(19) United States
(12) Patent Application Publication
(10) Pub. No.: US 2026/0127059 A1
(43) Pub. Date: May 7, 2026

(54) SYSTEM AND METHOD FOR MONITORING AND PREDICTING HEALTH CONDITION OF MULTIPLE COMPONENTS

(71) Applicant: Aivres Systems Inc., Fremont, CA (US)

(72) Inventor: Chi Yuan HSU, New Taipei City (TW)

(73) Assignee: Aivres Systems Inc., Fremont, CA (US)

(21) Appl. No.: 19/435,973

(22) Filed: Dec. 30, 2025

(51) Int. Cl. G06F 11/00; G01K 3/00

(52) U.S. Cl. CPC G06F 11/004; G01K 3/005; G06F 2201/81

(57) ABSTRACT

A system and method for monitoring and predicting a health condition for a computing system having multiple components are provided. The method includes: acquiring a plurality of time sequences of data (e.g., telemetry data) associated with a plurality of components of the computing system, and processing the plurality of time sequences of data to generate one or more predictive outputs predicting whether any of the plurality of components will be abnormal (e.g., to malfunction). The method also includes determining one or more mitigation actions in response to determining that the one or more predictive outputs include a first predictive output indicating that a first component, of the plurality of components, will be in an abnormal condition (e.g., malfunction at a predicted time). The method further includes performing the one or more mitigation actions (e.g., prior to the predicted time). The first component may be a hardware component or other component.

### TECHNICAL FIELD

The present disclosure relates generally to systems and methods for monitoring or predicting health condition(s) of multiple hardware components.

### BACKGROUND

With the rapid development in technologies such as cloud computing, big data, and artificial intelligence, the scale and complexity of data centers continue to increase, and there is a high demand on computing systems, such as server system(s). The reliability, availability, and serviceability (RAS) of a server system are key factors for evaluating a performance of the server system.

Hardware malfunction is a typical reason for outage or service interruption of a computing system, e.g., server system. Traditional approaches to handling server malfunction are usually passive, namely, to perform diagnosis and repair after the occurrence of a malfunction. These approaches are not only time-consuming, but also possibly result in severe data loss and economic damages. As a result, there is a need to develop methods and systems for proactively predicting and/or preventing occurrence of hardware malfunction.

### SUMMARY

Techniques are described herein for monitoring and/or predicting health condition(s) for a computing system (or an electronic system) that includes multiple components (e.g., CPU, storage device, fan, power supply unit, etc.).

According to one aspect of the present disclosure, a method is provided. In various embodiments, the method includes: acquiring a plurality of time sequences of data (e.g., telemetry data) associated with a plurality of hardware components of an electronic system; processing the plurality of time sequences of data (e.g., telemetry data) to generate one or more predictive outputs indicating whether any of the plurality of hardware components will be in an abnormal condition (e.g., malfunction); determining or predicting, based on a first predictive output of the one or more predictive outputs, that at least a first hardware component of the plurality of hardware component will be in an abnormal condition (e.g., malfunction) at a predicted time; determining one or more mitigation actions to mitigate the abnormal condition (e.g., malfunction) of the first hardware component; and performing the one or more mitigation actions prior to the predicted time.

In some embodiments, the plurality of hardware components includes one or more of: a central processing unit (CPU), a storage device, and a peripheral component interconnect express (PCIe) device. In some embodiments, acquiring the plurality of time sequences of telemetry data associated with the plurality of hardware components comprises: acquiring one or more time sequences of CPU telemetry data associated with the CPU; acquiring one or more time sequences of storage telemetry data associated with the storage device; and/or acquiring one or more time sequences of PCIe telemetry data associated with the PCIe device.

In some embodiments, acquiring one or more time sequences of CPU telemetry data includes: acquiring a first time sequence of CPU telemetry data from a machine check architecture (MCA) bank of the CPU that comprises one or more model-specific registers (MSRs), where the first time sequence of CPU telemetry data includes a series of corrected errors associated the CPU or a series of uncorrected errors associated with the CPU.

In some embodiments, additionally, or alternatively, acquiring one or more time sequences of CPU telemetry data includes: acquiring a second time sequence of CPU telemetry data from one or more error count registers of the CPU, where the second time sequence of CPU telemetry data includes a series of error counts associated with the CPU. In some embodiments, the series of error counts includes a first series of a total number of errors corrected for a memory controller of the CPU that couples the CPU with a memory and/or a second series of a total number of errors corrected for a QuickPath Interconnect (QPI) or an Ultra Path Interconnect (UPI) that couples the CPU with an additional CPU.

In some embodiments, additionally, or alternatively, acquiring one or more time sequences of CPU telemetry data includes: acquiring a third time sequence of CPU telemetry data associated with the CPU, where the third time sequence of CPU telemetry data is collected using a thermal sensor and comprising a series of temperatures values associated with a temperature of the CPU.

In some embodiments, additionally, or alternatively, acquiring one or more time sequences of CPU telemetry data includes: acquiring a fourth time sequence of CPU telemetry data associated with the CPU from the one or more MSRs or from power management firmware of the CPU.

In some embodiments, the fourth time sequence of CPU telemetry data includes a series of current operating frequencies, voltages, or power consumptions, associated with the CPU.

In some embodiments, the first time sequence, the second time sequence, the third time sequence, and the fourth time sequence, of CPU telemetry data, correspond to a same time period or correspond to different time periods. In some embodiments, the first time sequence, the second time sequence, the third time sequence, and the fourth time sequence, of CPU telemetry data can have a same sampling frequency or different sampling frequencies. As a non-limiting example, the first time sequence of CPU telemetry data and/or the second time sequence of CPU telemetry data include telemetry data points (e.g., error counts) sampled/collected at a first sampling frequency, and the third time sequence of CPU telemetry data can include telemetry data points (e.g., temperature values) sampled/collected at a second sampling frequency. In some embodiments, based on the variation of temperature values being slower than variation in values for error counts, the first sampling frequency can be higher than the second sampling frequency.

In some embodiments, acquiring one or more time sequences of storage telemetry data includes: acquiring a first time sequence of storage telemetry data reflecting a variation in a percentage of available space for the storage device; acquiring a second time sequence of storage telemetry data reflecting a variation in a total number of media and data integrity errors detected for the storage device; acquiring a third time sequence of storage telemetry data reflecting a variation in a percentage of a life used for the data storage; acquiring a fourth time sequence of storage telemetry data reflecting a variation in a temperature of the data storage; and/or acquiring a fifth time sequence of storage telemetry data reflecting a variation in a critical warning for a state of the data storage. In some embodiments, the first time sequence, the second time sequence, the third time sequence, the fourth time sequence, and the fifth time sequence, of storage telemetry data, can correspond to a same time period or correspond to different time periods. In some embodiments, the first time sequence, the second time sequence, the third time sequence, the fourth time sequence, and the fifth time sequence, of storage telemetry data, can be acquired under a same sampling frequency or under different sampling frequencies.

In some embodiments, acquiring one or more time sequences of PCIe telemetry data includes: acquiring a first time sequence of PCIe telemetry data reflecting a series of corrected errors associated with the PCIe device, acquiring a second time sequence of PCIe telemetry data reflecting a series of uncorrected errors associated with the PCIe device, acquiring a third time sequence of PCIe telemetry data reflecting a variation in a link speed of a PCIe link connected to the PCIe device, and/or acquiring a fourth time sequence of PCIe telemetry data reflecting a variation in a bandwidth of a PCIe link connected to the PCIe device. In some embodiments, the first time sequence, the second time sequence, the third time sequence, and the fourth time sequence, of PCIe telemetry data, can correspond to a same time period or correspond to different time periods. In some embodiments, the first time sequence, the second time sequence, the third time sequence, and the fourth time sequence, of PCIe telemetry data, can be acquired under the same sampling frequency or under different sampling frequencies.

In some embodiments, processing the plurality of time sequences of telemetry data, to generate one or more predictive outputs includes: processing a respective time sequence, of the plurality of time sequences of telemetry data, using an exponentially weighted moving average (EWMA) approach, to determine a trend of telemetry data variation for the respective time sequence.

In some embodiments, the first hardware component is the CPU. In this case, determining one or more proactive mitigation actions (also referred to as “one or more mitigation actions”) to mitigate the predicted abnormal condition (e.g., predicted malfunction) of the first hardware component includes: generating a high priority hardware error signal to a BMC or to an operating system, and transmitting the high priority hardware error signal to the BMC or to the operating system.

In some embodiments, the first hardware component is the CPU. In this case, determining one or more proactive mitigation actions to mitigate the predicted abnormal condition (e.g., predicted malfunction) of the first hardware component includes: flagging the CPU such that operation of the CPU is prohibited next time the electronic system is initiated.

In some embodiments, the first hardware component is the storage device or the PCIe device. In this case, determining one or more proactive mitigation actions to mitigate the predicted abnormal condition (e.g., predicted malfunction) of the first hardware component includes: prohibiting loading of a UEFI driver for the storage device or the PCIe device.

In some embodiments, the first hardware component is the storage device or the PCIe device. In this case, determining one or more proactive mitigation actions to mitigate the predicted abnormal condition (e.g., predicted malfunction) of the first hardware component includes: flagging the storage device or the PCIe device as “disabled” or “non present” in an ACPI table, to prevent an operating system from attempting to access the storage device or the PCIe device.

In some embodiments, additionally, or alternatively, the plurality of hardware components includes one or more of: a power supply unit (PSU), a system fan, and a voltage regulator module (VRM). In this case, processing the plurality of time sequences of telemetry data, to generate one or more predictive outputs may include: processing the plurality of time sequences of telemetry data, using one or more machine learning (ML) models, to generate the one or more predictive outputs.

In some embodiments, acquiring the plurality of time sequences of telemetry data associated with the plurality of hardware components includes: acquiring one or more time sequences of PSU telemetry data associated with the PSU; acquiring one or more time sequences of fan telemetry data associated with the fan; and/or acquiring one or more time sequences of VRM telemetry data associated with the VRM.

In some embodiments, acquiring the one or more time sequences of PSU telemetry data includes: acquiring a first time sequence of PSU telemetry data reflecting a variation in a value for an electrical parameter of the PSU, the electrical parameter being an input voltage, an output voltage, a current, or a power; acquiring a second time sequence of PSU telemetry data reflecting a variation in a value for a temperature of the PSU; acquiring a third time sequence of PSU telemetry data reflecting a variation in a status of a power of the PSU; acquiring a fourth time sequence of PSU telemetry data reflecting a variation in an abnormal condition indicator (e.g., a malfunction indicator) of the PSU; and/or acquiring a fifth time sequence of PSU telemetry data reflecting a variation in warnings of the PSU. The first time sequence, the second time sequence, the third time sequence, the fourth time sequence, and the fifth time sequence, of PSU telemetry data, correspond to a same time period or correspond to different time periods. The first time sequence, the second time sequence, the third time sequence, the fourth time sequence, and the fifth time sequence, of PSU telemetry data, can be collected or acquired under a same sampling frequency or different sampling frequencies.

In some embodiments, acquiring the one or more time sequences of fan telemetry data includes: acquiring a first time sequence of fan telemetry data reflecting a variation in a RPM of the fan; acquiring a second time sequence of fan telemetry data reflecting a variation in duty cycle associated with a Pulse Width Modulation (PWM) controlling signal that is transmitted to a fan; acquiring a third time sequence of fan telemetry data reflecting a variation in an operating status of the fan; acquiring a fourth time sequence of fan telemetry data reflecting a variation in a current of the fan; and/or acquiring a fifth time sequence of fan telemetry data reflecting a variation in a power of the fan. The first time sequence, the second time sequence, the third time sequence, the fourth time sequence, and the fifth time sequence, of fan telemetry data, correspond to a same time period or correspond to different time periods. The first time sequence, the second time sequence, the third time sequence, the fourth time sequence, and the fifth time sequence, of fan telemetry data, can be collected or acquired under a same sampling frequency or different sampling frequencies.

In some embodiments, acquiring the one or more time sequences of VRM telemetry data includes: acquiring a first time sequence of VRM telemetry data from a temperature sensor within a VRM region in proximity to one or more core hardware components of the electronic system, where the first time sequence of VRM telemetry data reflects a variation in a value of a temperature associated with the VRM.

In some embodiments, additionally, or alternatively, acquiring the one or more time sequences of VRM telemetry data includes: acquiring a second time sequence of VRM telemetry data reflecting a variation in an output voltage associated with the VRM; acquiring a third time sequence of VRM telemetry data reflecting a variation in an output current associated with the VRM; and/or acquiring a fourth time sequence of VRM telemetry data reflecting a variation in a phase health condition associated with the VRM.

In some embodiments, the first time sequence, the second time sequence, the third time sequence, and the fourth time sequence, of VRM telemetry data, correspond to a same time period or correspond to different time periods. In some embodiments, the first time sequence, the second time sequence, the third time sequence, and the fourth time sequence, of VRM telemetry data, can be collected or acquired under a same sampling frequency or different sampling frequencies.

According to one aspect of the present disclosure, a method is provided. In various embodiments, the method includes: acquiring a plurality of time sequences of telemetry data associated with a plurality of hardware components of a computing system; processing the plurality of time sequences of telemetry data, to generate one or more predictive outputs indicating whether any of the plurality of hardware components will be in an abnormal condition (e.g., malfunction); determining/predicting, based on a first predictive output of the generated one or more predictive outputs, that a first hardware component will be in an abnormal condition (e.g., malfunction); determining one or more mitigation actions to mitigate the predicted abnormal condition (e.g., predicted malfunction) of the first hardware component; and performing the one or more mitigation actions.

In some embodiments, the method further includes: generating an entry in a database to record the first predictive output and/or the one or more mitigation actions determined for the first hardware component.

According to one aspect of the present disclosure, a system is provided. In various embodiments, the system includes at least one processor; and memory storing instructions that, when executed by the at least one processor, cause the at least one processor to: acquire a plurality of time sequences of telemetry data associated with a plurality of hardware components of a server system; process the plurality of time sequences of telemetry data, to generate one or more predictive outputs predicting whether any of the plurality of hardware components is to be in an abnormal condition (e.g., malfunction); determine, based on a first predictive output of the generated one or more predictive outputs, that a first hardware component will be in an abnormal condition (e.g., malfunction) at a predicted time; determine (or predict) one or more mitigation actions to mitigate the predicted abnormal condition (e.g., predicted malfunction) of the first hardware component, and perform the one or more mitigation actions prior to the predicted time.

### BRIEF DESCRIPTION OF THE DRAWINGS

Systems and methods of the present disclosure are described in detail below with reference to the attached drawing figures, wherein:

FIG. 1 illustrates a block diagram of an example of a system according to one or more embodiments of the present disclosure.

FIG. 2A illustrates an example flowchart for a process of monitoring a health condition of a system, according to one or more embodiments of the present disclosure.

FIG. 2B illustrates an example flowchart showing collection of telemetry data, according to one or more embodiments of the present disclosure.

FIG. 2C illustrates an example flowchart showing processing of telemetry data, according to one or more embodiments of the present disclosure.

FIG. 2D illustrates an example flowchart showing determination of mitigation action(s), according to one or more embodiments of the present disclosure.

FIG. 2E illustrates an example flowchart showing recording and/or reporting one or more predictive malfunctions, according to one or more embodiments of the present disclosure.

FIG. 2F illustrates an example entry recording a predictive malfunction, according to one or more embodiments of the present disclosure.

FIG. 3 illustrates an example system for predictive management/monitoring of core hardware components, according to one or more embodiments of the present disclosure.

FIG. 4 illustrates another example system for predictive management/monitoring of multiple hardware components, according to one or more embodiments of the present disclosure.

FIG. 5 illustrates an example method for monitoring and predicting health conditions of multiple components of a system, according to one or more embodiments of the present disclosure.

### DETAILED DESCRIPTION

The following detailed description is exemplary in nature and is not intended to limit the disclosure or the application and uses of the described embodiments. Furthermore, there is no intention to be bound by any expressed or implied theory presented in the preceding background, summary and brief description of the drawings, or the following detailed description. Numerous specific details are set forth in order to provide a more thorough understanding of the disclosed technology. However, it will be apparent to one of ordinary skilled in the art that the disclosed technology may be practiced without these specific details. In other instances, well-known features have not been described in detail to avoid unnecessarily complicating the description.

Systems and methods are disclosed herein relate to monitoring or predicting health conditions for multiple hardware components of an electronic system (e.g., a single server, or a server system having one or more servers). The multiple hardware components may include, for instance, a central processing unit (CPU), a storage device (e.g., hard disk drive “HDD” or solid-state drive “SSD”), and/or a peripheral component interconnect express (PCIe) device. Additionally, or alternatively, the multiple hardware components may include a power supply unit (PSU), a fan of the system, and/or a voltage regulator module (VRM).

In various embodiments, data (e.g., condition-indicating data, such as telemetry data, local data, and/or any other applicable type of data that indicate health condition(s)) associated with the multiple hardware components is collected and processed, to determine a health condition for each of the multiple hardware components. In various embodiments, the data (e.g., telemetry data) can be, or can include, one or more time sequences (also referred to as “time series”) of data (e.g., telemetry data) for a hardware component, such that a health condition for the hardware component in a future time can be predicted. For example, the disclosed systems and methods may determine, based on processing the one or more time sequences of data (e.g., telemetry data) for the hardware component (e.g., using one or more machine learning models), that the hardware component is to malfunction at a predicted time. The predicted time may be, for instance, approximately 20 hours (or 2 days, etc.) since the collection of the one or more time sequences of data (e.g., condition-indicating data such as telemetry data or other types of data). In this example, the disclosed systems and methods may determine one or more mitigation actions (also referred to as “mitigation measures”) to mitigate, or prevent, the hardware component from entering an abnormal condition (e.g., the hardware component to malfunction). Correspondingly, the one or more determined mitigation actions can be performed prior to the predicted time at which the hardware component is predicted to be in an abnormal condition (e.g., malfunction).

In various embodiments, the disclosed monitoring or predicting system(s) can be embedded in firmware of a server, a server system, or other electronic system (e.g., a client device), and therefore can be independent of an operating system of the server, the server system, or the other electronic system. By embedding the disclosed monitoring or predicting systems in the firmware (e.g., Basic Input and Output System “BIOS,” Unified Extensible Firmware Interface “UEFI,” and/or System Management Mode “SMM,” etc.) that is separately stored with respect to the operating system, the disclosed systems and methods will not be affected when the operating system fails or crashes.

Further, the disclosed monitoring or predicting systems (or methods) can be applied to monitor or predict, e.g., at the same time, health conditions for a wide range of components of a server system or other electronic system. For example, the disclosed systems and methods can be applied to synchronously monitor or predict health conditions for hardware components including, but not limited to, one or more CPUs where each CPU has one or more CPU cores, one or more storage devices or memory, one or more PCIe devices of the same type (or different types), one or more PSUs, one or more fans, and one or more VRMs. As another example, the disclosed systems and methods can be applied to synchronously monitor or predict health conditions for hardware components additionally (or alternatively) include a network interface controller (NIC) or a Dual In-line Memory Module (DIMM).

In various embodiments, the disclosed systems and methods collect time sequences of telemetry data associated with one or more hardware components. This allows the disclosed systems and methods to predict health condition(s) for the one or more hardware components, e.g., to predict a malfunction for a hardware component (e.g., CPU) and/or a predicted time at which an abnormal condition (e.g., the malfunction) of the hardware component (e.g., CPU) is to occur. The disclosed systems and methods can further determine one or more mitigation actions for the hardware component that is predicted to be in an abnormal condition (e.g., is predicted to malfunction). The determined one or more mitigation actions can be proactive mitigation action(s) performed prior to the predicted time (at which the hardware component is predicted to malfunction). Compared to conventional mitigation actions performed after occurrence of hardware malfunction or other system malfunction, performance of the proactive mitigation action(s) often costs less, is more efficient and convenient, and allows continuous operation of the server system without abrupt interruption(s).

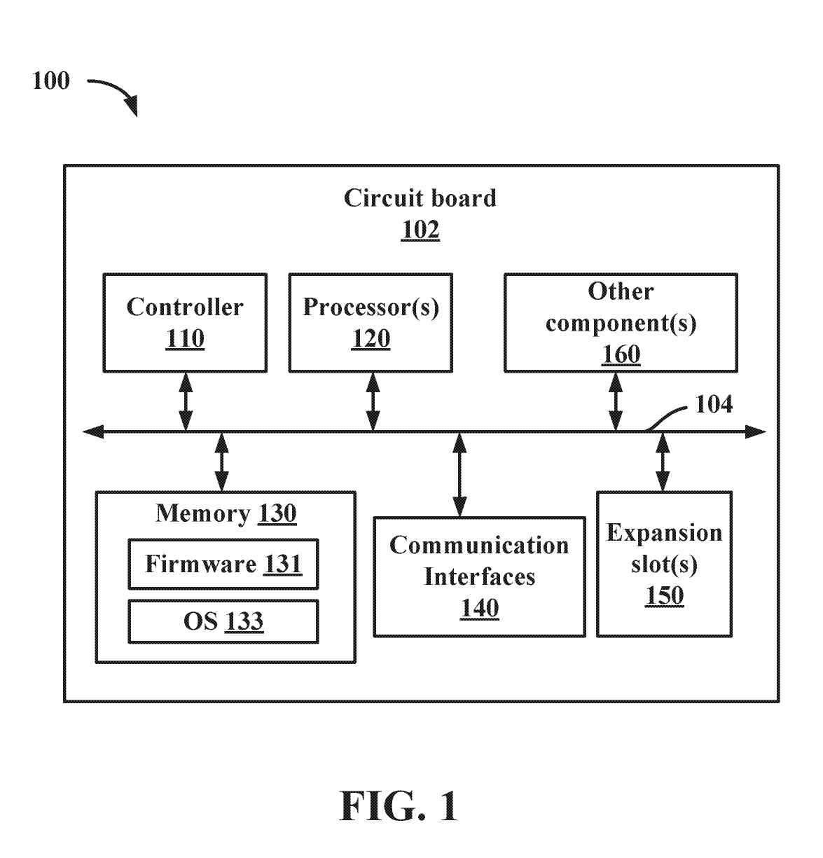

FIG. 1 illustrates a block diagram of a system 100, e.g., server or other computing system, electronic system or electronic device, suitable for use in implementing embodiments of the present disclosure. It should be noted that the arrangements described herein, including this example, are provided for illustrative purposes only. Alternative configurations and components may be used in place of or in addition to those shown, and some components may be omitted entirely. Moreover, many of the elements described are functional in nature and can be implemented as standalone or distributed components or devices, either independently or in combination with other components, and located in various configurations. The functions discussed may be executed through hardware, firmware, and/or software, with processes typically performed by a processor running instructions stored in memory. Additionally, those skilled in the art will recognize that any system capable of performing the operations of the system 100 falls within the scope and intent of the disclosed embodiments. The system 100, e.g., server, can be housed in a rack-mounted chassis designed for optimal airflow and cooling, ensuring efficient heat dissipation during operation. Yet further, a person skilled in the art will recognize that the systems and methods described herein can be used with electronic systems and computer systems other than server systems.

The system 100 typically includes at least one circuit board 102, e.g., a motherboard, that may carry various components, including hardware, firmware, and/or software, which may be integrated with, attached to, connected to, or in communication with the motherboard. As shown in FIG. 1, the circuit board 102 carries at least one controller 110, such as a baseboard management controller (BMC) and/or an embedded controller (EC), one or more processors 120, memory 130, communication interfaces 140, one or more expansion slots 150, and one or more other components 160. Such components and the circuit board 102 can communicate with one another through a bus 104, which may be integrated into the circuit board 102.

Processor(s) 120 may be configured to perform the operations in accordance with the computer readable instructions stored in memory 130. In certain embodiments, the memory 130 may be integral to the processor(s) 120. In other embodiments, the memory may in whole or in part be separate from the processor(s) 120. Processor(s) 120 may include any appropriate type of general-purpose or special-purpose microprocessor or microcontroller (e.g., a central processing unit (CPU) or graphics processing unit (GPU), respectively), digital signal processor, microcontroller, or the like. Memory 130 may be configured to store computer-readable instructions that, when executed by processor(s) 120, can cause processor(s) 120 to perform various operations disclosed herein and/or store data relating thereto.

Memory 130 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), an electrical erasable programmable ROM (EEPROM), a flash memory, a dynamic random-access memory (“RAM”), and/or a static RAM. In various embodiments, memory 130 may include multiple storage devices of various types. For example, memory 130 can include a volatile memory (e.g., RAM) and one or more non-volatile storage devices (e.g., flash memory, a solid-state drive “SSD”, ROM, etc.).

In various embodiments, firmware 131 (e.g., BIOS/UEFI firmware, etc.) is stored in flash memory (or other non-volatile storage device), and an operating system (OS) 133 is stored in a separate storage device accessible to Processor(s) 120, such as a hard drive (e.g., SSD). In some embodiments, memory 130 may store both the firmware 131 and the operating system 133. The firmware 131 can provide initial software and logic to load the operating system 133, and/or provide other logic for operation of the system 100 (such as basic operation to interconnect different components of the system 100). The operating system 133 can include a program of executable instructions that, after being loaded (e.g., into a RAM) by a boot program, manage or control hardware resources and application programs hosted by the operating system 133, and/or manage network communication. In some embodiments, the firmware 131 (or a portion thereof) can operate parallel to, and/or in the background of, the operating system 133.

Communication interfaces 140 may be configured to communicate information between system 100 and other devices or systems. For example, communication interfaces 140 may include an integrated services digital network (“ISDN”) card, a cable modem, a satellite modem, or a modem to provide a data communication connection. As another example, communication interfaces 140 may include a local area network (“LAN”) card to provide a data communication connection to a compatible LAN. As a further example, communication interfaces 140 may include a high-speed network adapter such as a fiber optic network adaptor, 10G Ethernet adaptor, or the like. Wireless links can also be implemented by communication interfaces 140. In such an implementation, communication interfaces 140 can send and receive electrical, electromagnetic, or optical signals that carry digital data streams representing various types of information via a network. The network can typically include a cellular communication network, a Wireless Local Area Network (“WLAN”), a Wide Area Network (“WAN”), or the like.

Controller 110, e.g., BMC or EC, may include a processing unit, associated memory, and communication interfaces, and is configured to monitor and manage the system’s hardware components among other things. Controller 110 handles tasks such as remote system management, including hardware health monitoring, system event logging, and power control. Controller 110 can operate independently of the system’s 100 main processor (e.g., processor(s) 120), allowing for out-of-band management. Controller 110 may in certain embodiments facilitate communication with various sensors (e.g., other component(s) 160) on the circuit board 102 to track temperature, fan speed, voltage levels, and other critical parameters. Additionally, the controller 110 may include network interfaces and/or operate in conjunction with communication interfaces 140 to enable remote access for system administrators, providing a way to perform diagnostic tasks, power cycling, and firmware updates.

The expansion slot(s) 150 on the circuit board 102 may be used for connecting additional peripherals, such as GPUs, network cards, and more.

The other components 160 can include integrated components, replaceable components, and other suitable components. For example, these components may include but are not limited to sensors, cooling devices, power supply modules (and/or connectors), clock generators, chipsets, and more. In one or more embodiments, a chipset refers to a component or a group of components that manage communication between the CPU, memory (RAM), storage devices, network interfaces, and other peripherals.

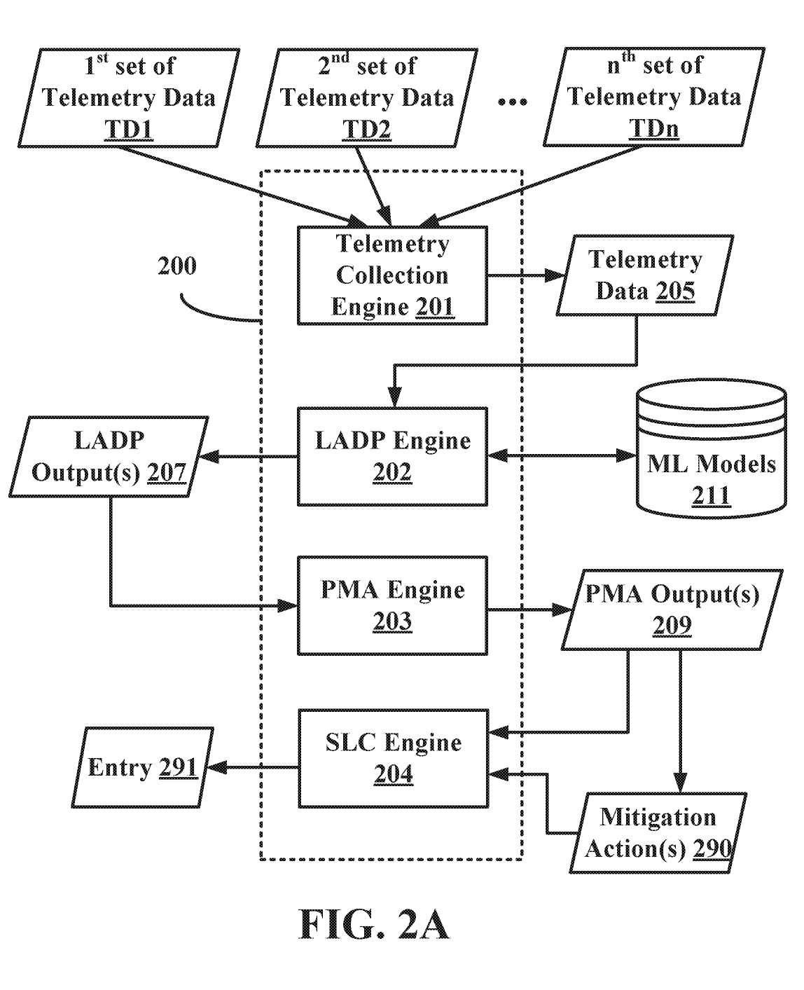

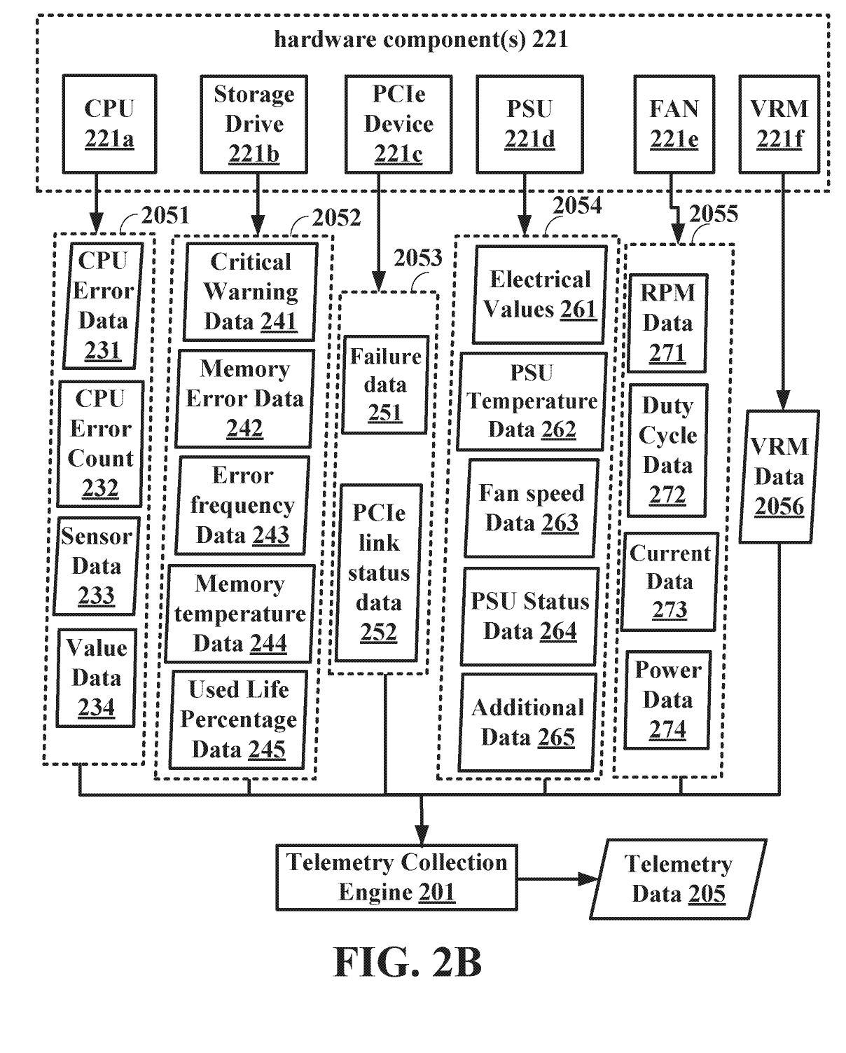

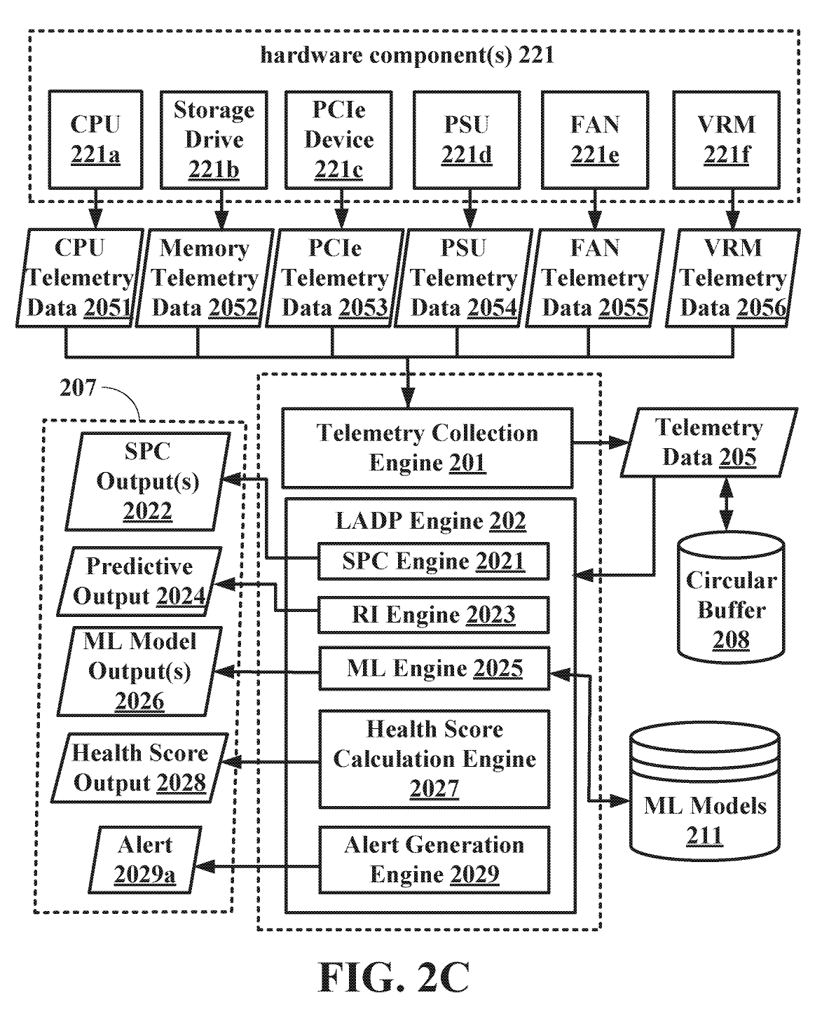

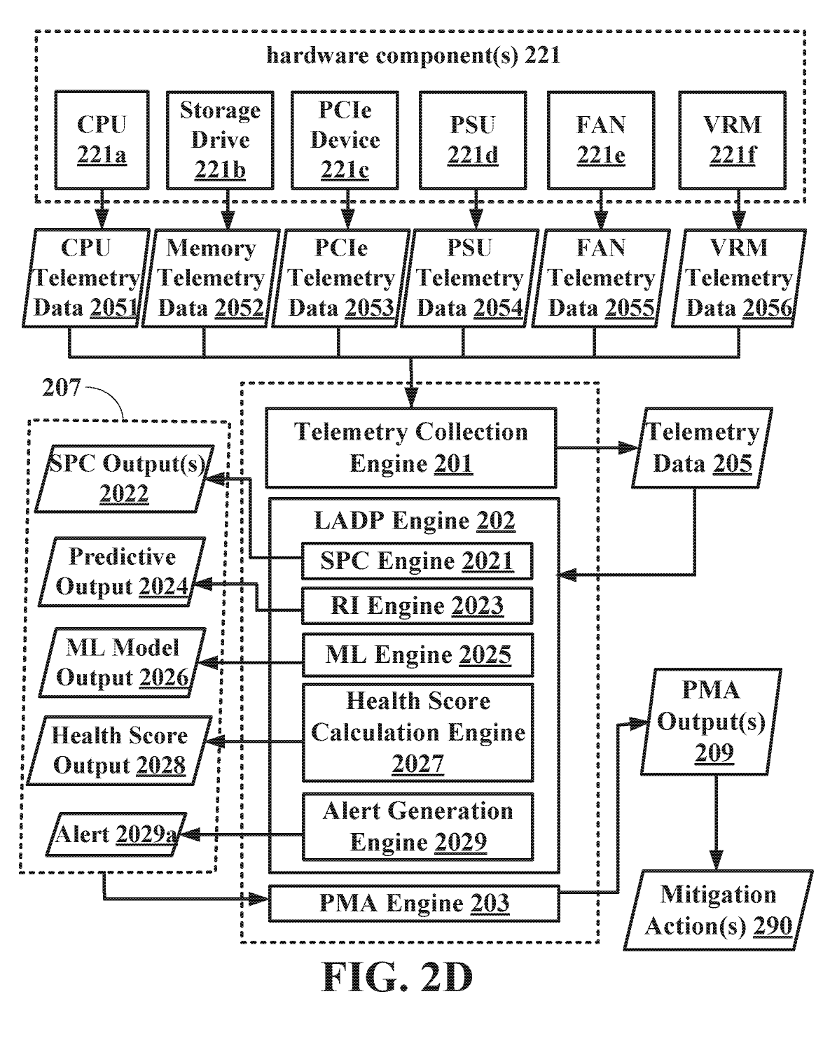

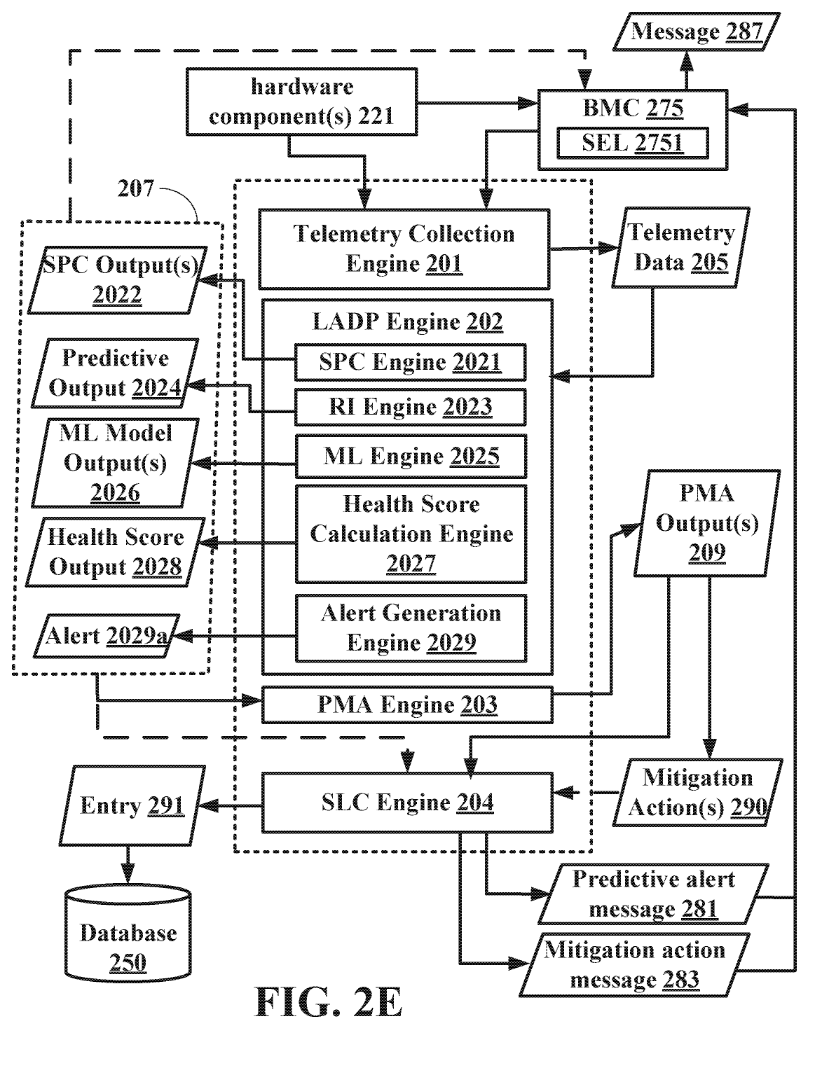

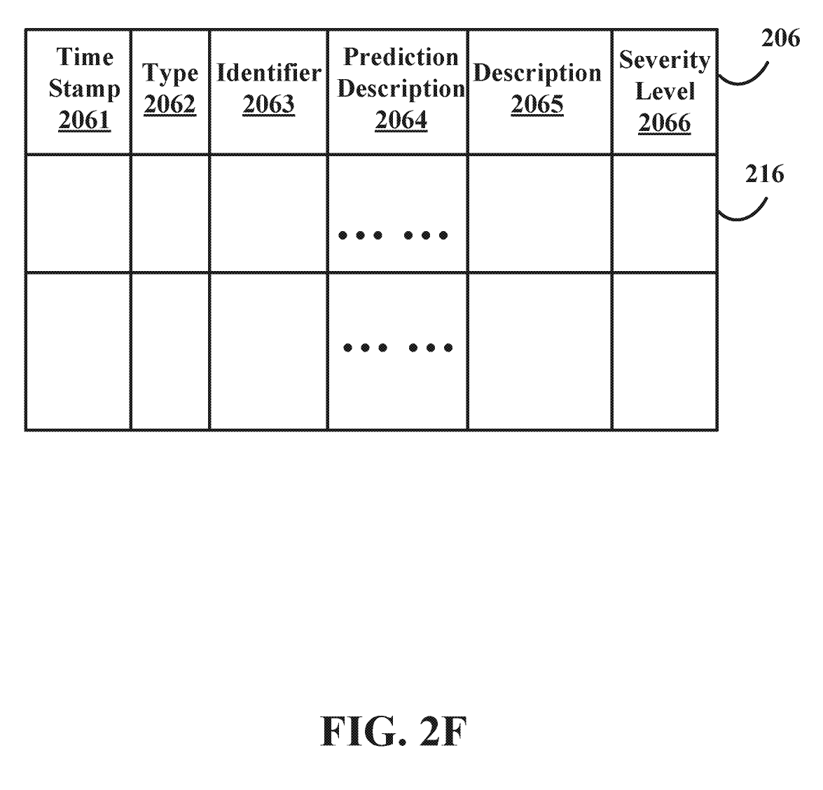

FIG. 2A illustrates an example flowchart for a process of monitoring a health condition of a system having multiple components, according to one or more embodiments of the present disclosure. In various implementations, various engines of a health condition monitoring and prediction system 200 depicted in FIG. 2A can be included (e.g., embedded) in system firmware of the system having multiple components, where the system can be a server system (e.g., depicted in FIG. 1) or any other applicable computing system or electronic system (e.g., robot). By including the various engines depicted in FIG. 2A in the system firmware (e.g., server system firmware, or firmware for an embedded system such as a vehicle or robot), health condition of the system prior to the loading of an operating system associated with the system can be implemented. Further, monitoring of the health condition of the system will not be interrupted even when the operating system fails. This is because the firmware is stored separately from the operating system, and therefore is independent of the operating system.

Additionally, or alternatively, in some embodiments, the health condition monitoring and prediction system 200 comprising the various engines depicted in FIG. 2A may be included as part of the operating system associated with the system, or be included as part of a controller (e.g., basic management controller, “BMC”).

In various implementations, as shown in FIG. 2A, the health condition monitoring and prediction system 200 can include a telemetry collection engine 201, a lightweight anomaly detection & predictive (LADP) engine 202, and/or a proactive mitigation & action (PMA) engine 203. In various implementations, the health condition monitoring and prediction system 200 is a firmware-based system, e.g., a system embedded in firmware of a server system (e.g., “100” in FIG. 1) or other computing (or electronic) system. In this case, the telemetry collection engine 201 can be referred to as a firmware telemetry collection (FTC) engine. The telemetry collection engine 201 (e.g., the FTC engine) can be configured for collecting value(s) of parameter(s), or other data, that indicate a health condition of a server system (e.g., a single server, or one or more servers), or other types of system (e.g., vehicle, smart phone, robot, etc.).

In various embodiments, the telemetry collection engine 201 can be applied for collecting or generating condition-indicating data (e.g., telemetry data 205) based on receiving and/or pre-processing, respectively, a 1^{st} set of data (e.g., telemetry data TD1), a 2^{nd} set of data (e.g., telemetry data TD2), …, an n^{th}^{st} set of telemetry data TD1 can include one or more types of telemetry data associated with a first hardware component (e.g., a CPU), the 2^{nd} set of telemetry data TD2 can include one or more types of telemetry data associated with a second hardware component (e.g., a storage device), …, and the n^{th} set of telemetry data TDn can include one or more types of telemetry data associated with an N^{th} hardware component (e.g., a heat-dissipation fan). It will be understood that the particular hardware components identified are by way of example and not limitation.

In some embodiments, the one or more types of data (e.g., telemetry data and/or other condition-indicating data) associated with the i^{th} hardware component in the i^{th}^{th} hardware component at a particular time point (or over a time period). In some embodiments, the telemetry collection engine 201 can receive (and/or time stamp) the 1^{st} set of data (e.g., the telemetry data TD1), the 2^{nd} set of data (e.g., the telemetry data TD2), …, and the n^{th} set of data (e.g., the telemetry data TDn), e.g., in a real-time manner, on a regular basis, etc.

In various implementations, the telemetry collection engine 201 can pre-process the 1^{st} set of data (e.g., telemetry data TD1), the 2^{nd} set of data (e.g., telemetry data TD2), …, and/or the n^{th} set of data (e.g., telemetry data TDn), to generate data (e.g., the telemetry data 205) that includes one or more time-stamped set of telemetry data. As a working example, the telemetry collection engine 201 can pre-process the n^{th} set of telemetry data TDn, to generate a first time-stamped set of telemetry data associated with the N^{th} hardware component (e.g., heat-dissipation fan) and/or a second time-stamped set of telemetry data associated with the n^{th} hardware component. The first time-stamped set of telemetry data associated with the n^{th} hardware component can be, for instance, a time sequence of temperature values for a temperature associated with a region of the heat-dissipation fan over a predefined time period. The second time-stamped set of telemetry data associated with the N^{th} hardware component can be, for instance, a time sequence of values for a speed (e.g., revolutions per minute, “RPM”) associated with the heat-dissipation fan over the predefined time period (or a different predefined time period having a different duration, a different starting time, and/or a different ending time). Continuing with the working example above, the first time-stamped set of telemetry data associated with the n^{th} hardware component and the second time-stamped set of telemetry data associated with the n^{th} hardware component are then included in the telemetry data 205, along with (or without) time-stamped set(s) of telemetry data associated with other hardware component(s). The telemetry data 205 may be transmitted to the LADP engine 202 for further processing.

In some embodiments, the telemetry data 205 may include, for instance, values of parameters indicating health conditions of the multiple hardware components of the server system. The multiple hardware components can include, for instance, one or more CPUs, a memory, one or more storage devices (e.g., HDD, SSD, etc.), one or more PCle devices, one or more power supply units (PSUs), one or more fans, a voltage regulation module (VRM), etc. In some embodiments, the one or more fans can be located at different regions of the server system or be distributed over the server system. For example, the one or more fans can include a first fan in proximity to a CPU and/or a second fan in proximity to a storage device.

In various implementations, the LADP engine 202 can be configured to process the telemetry data 205 collected (or generated) using the telemetry collection engine 201, to generate one or more LADP outputs 207. The one or more LADP outputs 207 can include one or more detection outputs indicating whether an abnormal mode of the server system is detected, one or more determination outputs (e.g., one or more health scores) indicating a health condition of the server system, and/or one or more prediction outputs predicting an occurrence of an abnormal condition (e.g., malfunction, such as hardware malfunction) for the server system. In some implementations, one or more machine learning (ML) models 211 can be applied to process the telemetry data 205, to generate one or more model outputs. In this case, the one or more LADP outputs 207 of the LADP engine 202 can be derived, e.g., entirely or partially, from the one or more model outputs.

For example, the one or more model outputs can be processed to generate the one or more detection outputs indicating whether an abnormal mode of the server system is detected, or to generate a portion of the one or more detection outputs. Additionally, or alternatively, the one or more model outputs can be processed to generate the one or more determination outputs indicating a health condition of the server system, or to generate a portion of the one or more determination outputs. Additionally, or alternatively, the one or more model outputs can be processed to generate the one or more prediction outputs predicting an occurrence of hardware malfunction for the server system, or to generate a portion of the one or more prediction outputs.

In some implementations, additionally, or alternatively, one or more calculations can be performed to generate the aforementioned one or more LADP outputs 207 (or a portion thereof), where the one or more calculations can be rule-based and/or statistic-based.

In some implementations, the one or more ML models 211 can include one or more decision tree models, one or more random forests models, one or more support vector machine (SVM) classifiers, one or more autoencoders, one or more isolation forest models, one or more Bayesian networks, and/or any other applicable machine learning model(s). For example, the one or more ML models 211 may alternatively, or additionally, include one or more recurrent neural networks (RNNs), one or more long short-term memory (LSTM) models, and/or one or more graphical neural networks (GNNs). The one or more RNNs or LSTMs may be applied to process time sequences of telemetry data (e.g., values of a temperature detected continuously for a hardware component over a time period). The one or more GNNs may be applied to process telemetry data collected from different hardware components, to determine or predict, e.g., malfunction of a first hardware component in dependence on a second hardware component (which is different from the first hardware component).

In various implementations, the PMA engine 203 can receive the one or more LADP outputs 207 generated based on processing the set of telemetry data 205 from the LADP engine 202. In various implementations, the PMA engine 203 can generate a PMA output 209 based on processing the one or more LADP outputs 207 that are generated based on processing the telemetry data 205. The PMA output 209 can include or indicate whether one or more mitigation actions/measures 290 need to be performed. In some implementations, the PMA output 209 can further include, for each of the one or more mitigation actions/measures 290, a time associated with (e.g., a time or a deadline to perform) a corresponding mitigation action/measure. In some implementations, the PMA engine 203 can generate one or more control signals based on the PMA output 209, and the one or more mitigation actions/measures 290 (or a portion thereof) can be performed based on the one or more control signals.

In some embodiments, the one or more mitigation actions/measures 290 can include a proactive mitigation action predicted for a hardware component (e.g., a CPU), and the time associated with the proactive mitigation action can be a predicted time at which the hardware component is predicted to malfunction. In this case, the proactive mitigation action may be performed prior to the predicted time, to avoid or mitigate malfunction of the hardware component that is predicted to malfunction. By performing the proactive mitigation action prior to the predicted time (e.g., 5 min or 1 hour before the predicted time), not only the risk of malfunction of the hardware component is reduced, but also the cost associated with possible system crash caused by occurrence of malfunction of the hardware component can be reduced, along with other benefits of performing proactive measures to ensure continuous and normal operation of the server system (or other computing or electronic systems like a vehicle, robot fleet, etc.).

In various implementations, referring to FIG. 2A, the health condition monitoring and prediction system 200 can additionally, or alternatively, include a secure logging and communication (SLC) engine 204. In some implementations, the SLC engine 204 can generate an entry (e.g., “291” for storage in a file or a database) based on the PMA output 209 and/or the one or more mitigation actions 290. For instance, in some implementations, the SLC engine 204 can generate an entry based on whether the PMA output 209 indicates any mitigation action to be performed. The entry can include a description of the mitigation action determined to be performed, and/or performance data (e.g., date, time, location, etc.) associated with the mitigation action once it is performed. In some other implementations, the SLC engine 204 can generate an entry each time a PMA output is generated, regardless of whether the generated PMA output indicates a mitigation action to be performed or not.

In various implementations, as a non-limiting example, referring to FIG. 2B, the telemetry collection engine 201 (e.g., embedded in firmware) can generate telemetry data 205 associated with one or more hardware components 221 of a server system (e.g., a server) based on receiving telemetry data associated with each of the one or more hardware components 221. The one or more hardware components 221 can include a first hardware component, e.g., a central processing unit (CPU) 221a. Correspondingly, the telemetry data 205 can include a set of CPU telemetry data 2051 that is associated with the CPU 221a. The set of CPU telemetry data 2051 may include, for instance, CPU error data 231 retrieved from a Machine Check Architecture (“MCA”) bank of the CPU 221a that comprises one or more registers (e.g., one or more Model-specific registers, “MSRs”). The CPU error data 231 retrieved from the MCA bank can correspond to a time point, or can correspond to a time period.

The CPU error data 231 retrieved from the MCA bank 2211 can include, for instance, one or more corrected errors and/or one or more uncorrected errors, where the errors here can be cache error, translation-lookaside buffer (TLB) error, and/or bus error. The one or more MSRs can include, for instance, an IA32_MCi_STATUS MSR and/or an IA32_MCi_ADDR MSR. The set of CPU telemetry data 2051 may be processed (alone or in combination or other telemetry data), using the LADP engine 202, e.g., to predict occurrence of an error to be encountered by the CPU 221a. For instance, the CPU error data 231 retrieved from the MCA bank of the CPU 221a may indicate that a specific type of corrected error occurs frequently or continuously. Such CPU error data 231 can indicate that the CPU 221a is soon to experience an error of the specific type. In some embodiments, the CPU error data 231 may reflect a pattern for occurrence of the corrected error of the specific type. In this case, the LADP engine 202 may predict, based on processing the CPU error data 231, a time that the error of the specific type is to occur for the CPU 221a.

Additionally, or alternatively, the set of CPU telemetry data 2051 may include, one or more error counts 232 retrieved from one or more error count registers. The one or more error count registers can include, for instance, a first error count register that counts a total number of errors corrected for a memory controller, and/or a second error count register that counts a total number of errors corrected for QuickPath Interconnect (QPI) or Ultra Path Interconnect (UPI). The memory controller is a hardware component of the CPU 221a for coupling the CPU 221a with a memory. The QPI or UPI is a scalable processor interconnect for connecting the CPU 221a to another CPU. For instance, a QPI interconnect can communicatively couple a first CPU socket of the CPU 221a to a second CPU socket of the other CPU. The one or more error counts 232 can be processed, using the LADP engine 202, to reflect an variation rate and/or an absolute value for each of the one or more error counts 232.

Additionally or alternatively, the set of CPU telemetry data 2051 may include, sensor data 233 associated with the CPU 221a. The sensor data 233 can be, or can include, one or more temperature values collected using a digital thermal sensor (DTS) of the CPU 221a. The one or more temperature values can reflect a real-time temperature of the CPU 221a. The one or more temperature values, either too high (e.g., exceeding a predefined upper temperature limit, such as “65°C”) or reflecting an abnormal temperature variation (e.g., a dramatic change in temperature within seconds), can be an indication of a malfunction of the CPU 221a.

Additionally or alternatively, the set of CPU telemetry data 2051 may include, parameter values (also referred to as “value data”) 234 associated with an operating frequency, voltage, and/or a power consumption status of the CPU 221a. Such parameter values 234 can be read from one or more MSRs including, for instance, a maximum performance clock counter (e.g., IA32_MPERF) and/or an actual performance clock counter (e.g., IA32_APERF). Alternatively, the parameter values 234 can be acquired through interaction with power management firmware of the CPU 221a. Variation of the parameter values 234 may reflect a load condition of the CPU 221a and/or indicate a reduced operating speed and/or lowered voltage that provide a battery-optimized mode (known as “CPU throttling”).

Continuing with the non-limiting example above and further referring to FIG. 2B, the one or more hardware components 221 can, additionally, or alternatively, include a second hardware component, e.g., a storage drive 221b. The storage drive 221b can be, for instance, a solid-state drive (e.g., a Non-Volatile Memory Express SSD, “NVMe SSD”), or a hard disk drive (HDD). The telemetry data 205 can include a set of memory telemetry data 2052 that is associated with the storage drive 221b. The set of memory telemetry data 2052 can include values (or time sequences) for one or more Self-Monitoring Analysis and Reporting Technology (S.M.A.R.T.) attributes that are associated with the storage drive 221b. Such values (or time sequences) for S.M.A.R.T. attributes can be referred to as “SMART data.”

The one or more S.M.A.R.T attributes associated with the storage drive 221b can include, for instance, one or more critical warnings to indicate one or more severe conditions. The one or more severe conditions can include, for instance, available spare space of the storage drive 221b has fallen below a threshold, a temperature of the storage drive 221b is above an over-heat temperature threshold (e.g., 65^{o}C) or below an under-temperature threshold (e.g., 5^{o}C), reliability of the storage drive 221b has been degraded due to media related errors or other internal error, the storage drive 221b has been placed in a read-only mode, and/or backup failure of the storage drive 221b (or a volatile memory thereof). Each of the one or more severe conditions indicates that the storage device 221b is in an unstable/unhealthy condition, or an error is to occur for the storage drive 221b. In this case, the SMART data can include critical warning data 241 comprising or indicating content or values associated with the one or more critical warnings.

Additionally, or alternatively, the one or more S.M.A.R.T attributes associated with the storage drive 221b can include one or more media and data integrity error counts indicating a total number of occurrences of for each type of unrecovered media and data integrity error(s). The unrecovered media and data integrity error(s) can include: an uncorrectable error correction code (ECC) error indicating that the ECC mechanism detects an uncorrectable error in data storage using the storage drive 221b, a cyclic redundancy check (CRC) checksum failure indicating the lack of integrity of data stored in the storage drive 221b, or a logical block address (LBA) tag mismatch indicating an error in a data path of the storage drive 221b. In this case, the SMART data can include memory error data 242 indicating content or values associated with the one or more media and data integrity error counts.

Additionally, or alternatively, the one or more S.M.A.R.T attributes associated with the storage drive 221b can include a total number of error log page entries indicating a frequency of historical errors. In this case, the SMART data can include error frequency data 243 indicating content or values associated with the frequency of historical errors. Additionally, or alternatively, the one or more S.M.A.R.T attributes associated with the storage drive 221b can include a reading of a temperature of a thermal sensor inside the storage drive 221b. In this case, the SMART data can include memory temperature data 244 indicating content or values associated with the temperature reading of the thermal sensor inside the storage drive 221b. Additionally, or alternatively, the one or more S.M.A.R.T attributes associated with the storage drive 221b can include a percentage of a life of the storage drive 221b that is expected to have been used (this is a factor for evaluating a degree of wear of the storage drive 221b). In this case, the SMART data can include used life percentage data 245 indicating content or values associated with the percentage of the life of the storage drive 221b that is expected to have been used.

Values or content for the one or more S.M.A.R.T attributes associated with the storage drive 221b (e.g., NVMe SSD) can be acquired by executing Basic Input and Output System (BIOS) code (or Unified Extensible Firmware Interface (UEFI) code, or other system initialization code), or using system management mode (SMM) code. For example, if the storage drive 221b is a NVMe SSD, the BIOS code (or UEFI code), or the SMM code, or a portion of the BIOS code (or UEFI code or the SMM code), can be executed to read the one or more S.M.A.R.T attributes through a NVMe protocol (e.g., by using a Get Log Page command and designating the Log Identifier as “SMART/Health Information Log”). In some embodiments, the telemetry collection engine 201 can acquire values or content for the one or more S.M.A.R.T attributes (e.g., the aforementioned one or more critical warnings, the one or more media and data integrity error counts, the total number of error log page entries, the reading of the temperature of the thermal sensor inside the storage drive 221b, the percentage of the life of the storage drive 221b that is expected to have been used), e.g., on a regular basis. In some embodiments, values for different S.M.A.R.T attributes can be acquired at different time intervals. In some embodiments, the BIOS or UEFI can visit the storage drive 221b to acquire the values or content for the one or more S.M.A.R.T attributes prior to or during an initialization stage (e.g., of an operating system).

Different from performing a traditional, single check of essential hardware components (e.g., CPU 221a, video card, etc.) during the Power-On Self-Test (POST) process (which performs after the server system is powered on and before an operating system loads), the present disclosure can actively and continuously acquire health-indicating data that indicates a health condition of the server system. The health-indicating data can include, but is not limited to, values for the one or more S.M.A.R.T attributes associated with the storage drive 221b. For example, the health-indicating data can include any other applicable type of data, such as the aforementioned set of CPU telemetry data 2051 or subsequently described PCIe telemetry data 2053, etc. The present disclosure can acquire, for multiple times, periodically, or in a real-time manner (e.g., every few seconds), such health-indicating data prior to, during, or after initialization of the operating system which manages the operation of components of the server system.

Continuing with the non-limiting example above and further referring to FIG. 2B, the one or more hardware components 221 can, additionally, or alternatively, include a third hardware component, e.g., a Peripheral Component Interconnect Express (PCIe) device 221c (or other peripheral device). Correspondingly, the telemetry data 205 can include a set of PCIe telemetry data 2053 that is associated with the PCIe device 221c. The set of PCIe telemetry data 2053 that is associated with the PCIe device 221c can include, for instance, failure information 251 retrieved/read from an advanced error reporting (AER) capability structure of the PCIe device 221c. The AER capability structure supports AER error reporting which provides more detailed and robust failure information than baseline error reporting which is supported by two sets of configuration registers (e.g., device status register(s) and capability register(s)) of the PCIe device 221c.

For example, while the baseline error reporting provides minimized error reporting, the AER error reporting can indicate detection of receiver error (e.g., recorded in the AER register(s) during speed change and power management procedures) and/or poisoned Transaction Layer Packet (TLP), which are stored in corrected error status register and uncorrectable error status register (collectively “AER registers”) of the AER capability structure and/or associated error counter(s). The failure information 251 retrieved/read from an advanced error reporting (AER) capability structure can indicate a stability of a PCIe link connecting the PCIe device 221c and a health condition of the PCIe device 221c.

Additionally, or alternatively, the set of PCIe telemetry data 2053 that is associated with the PCIe device 221c can include PCIe link status data 252 indicating a status of one or more PCIe links connected to the PCIe device 221c. For example, the PCIe link status data 252 can indicate a link speed (e.g., Gen3 operates at 8 GT/s, Gen4 operates at 16 GT/s, Gen5 operates at 32 GT/s) and a bandwidth (e.g., x1, x2, x4, x8, x16, x32), and/or an error status (if any) of one or more of the PCIe links. Frequent link training of a PCIe link or severely downgraded speed (and/or width) of the PCIe link (e.g., downgraded speed from 32GT/s to 4 GT/s) can indicate a lack of integrity of signal(s) transmitted via the PCIe link (that is connected to the PCIe device 221c) or indicate that the PCIe device 221c is to malfunction (e.g., at a predicted time).

In some embodiments, the PCIe device 221c may not include the AER capability structure. In this case, the subset of PCIe telemetry data 2053 that is associated with the PCIe device 221c can include failure information 251 retrieved/read from the two sets of configuration registers of the PCIe device 221c.

Continuing with the non-limiting example above and further referring to FIG. 2B, the one or more hardware components 221 can, additionally, or alternatively, include a fourth hardware component, e.g., a power supply unit (PSU) 221d. Correspondingly, the telemetry data 205 can include a set of PSU telemetry data 2054 that is associated with the PSU 221d. The set of PSU telemetry data 2054 that is associated with the PSU 221d can include, for instance, electrical values 261 for one or more electrical parameters (e.g., input voltage, output voltage, current, and/or power, etc.) of the PSU 221d. Whether electrical value(s) 261 for one or more electrical parameters of the PSU 221d are within corresponding predefined range(s) can indicate whether the PSU 221d operates stably. For instance, abnormal voltage variation or continuous overcurrent (or undercurrent) can indicate malfunction or degradation of the PSU 221d.

Additionally, or alternatively, the set of PSU telemetry data 2054 can include PUS temperature data 262 having one or more temperature values of a temperature read from a temperature sensor inside the PSU 221d. A temperature value associated with the PSU 221d, if exceeding an upper temperature limit (e.g., 65^{o}C), can indicate that the PSU 221d is overloaded or has poor heat dissipation. Additionally, or alternatively, the set of PSU telemetry data 2054 associated with the PSU 221d can include a fan speed data 263 (e.g., revolutions per minute, “RPM”) having one or more values for a fan speed of a cooling fan inside the PSU 221d. Malfunction of the cooling fan can result in the temperature of the PSU 221d to exceed the upper temperature limit.

Additionally, or alternatively, the set of PSU telemetry data 2054 can include PSU status data 264 showing a “Power Good” status which indicates that power voltage(s) are within a predefined voltage range for normal operation of the PSU 221d, a malfunction indicator reported by the PSU 221d, and/or warnings (e.g., for overvoltage, undervoltage, overcurrent, over heat, etc.) reported using the Power Management Bus (PMBus) protocol. Additionally, or alternatively, the set of PSU telemetry data 2054 may include additional data 265 indicating a health condition of the PSU 221d, where the additional data 265 is usually acquired using custom I2C command(s) and register(s) that are manufacturer-specific and that are beyond standardized PMBus protocol. The aforementioned additional data 265 can include, but is not limited to, output voltage ripple, evaluation values for a stress level or degradation degree of inner components (e.g., capacitor, MOSFET) of the PSU 221d. A baseboard management controller (BMC, see “275” in FIG. 2E) is often applied to access the additional data described herein.

Continuing with the non-limiting example above and further referring to FIG. 2B, the one or more hardware components 221 can, additionally, or alternatively, include one or more fifth hardware components, e.g., one or more fans 221e. Correspondingly, the telemetry data 205 can include a set of fan telemetry data 2055 that is associated with the one or more fans 221e. The subset of fan telemetry data 2055 that is associated with the fan 221e can include RPM data 271 having one or more values for RPM for each of the one or more fans 221e. If a RPM for a fan is lower than an upper speed limit of the fan, or the RPM is “0” or the value of the RPM is not stable, the fan has malfunctioned or is to malfunction.

Additionally, or alternatively, the set of fan telemetry data 2055 can include duty cycle data 272 having value(s) for a duty cycle of a Pulse Width Modulation (PWM) controlling signal that is transmitted to a fan of the one or more fans 221e. The values for the duty cycle may be compared to the RPM of the fan, to determine whether a response from the fan is normal. Additionally, or alternatively, the set of fan telemetry data 2055 can include an operating status (e.g., labeled as “normal,” “malfunction,” or “missing”) of the one or more fans 221e. Additionally, or alternatively, the set of fan telemetry data 2055 can include current data 273 indicating values for current(s) of an electric motor (if supported by sensors associated with the one or more fans 221e). Additionally, or alternatively, the set of fan telemetry data 2055 can include power data 274 indicating values for power of an electric motor (if supported by sensors associated with the one or more fans 221e). For example, a smart fan or fan controller may provide readings of a current (and/or a power) of the electric motor. The current of the electric motor, if increased in an abnormal way, can indicate a wear of electric motor bearing(s), foreign object stuck, or the motor windings are to be in an open-circuit condition. These are indicators for predicting mechanical or electrical malfunction of the one or more fans 221e.

Continuing with the non-limiting example above and further referring to FIG. 2B, the one or more hardware components 221 can, additionally, or alternatively, include a sixth hardware component, e.g., a voltage regulator module (VRM) 221f. Correspondingly, the set of telemetry data 205 can include a set of VRM telemetry data 2056 that is associated with the VRM 221f. The subset of VRM telemetry data 2056 that is associated with the VRM 221f can include temperature value(s) of a temperature read from a temperature sensor within a VRM region of the server system that is in proximity to key components (e.g., CPU, memory) of the server system. The temperature value(s), if exceed a predetermined upper limit and continue to exceed the predetermined upper limit for a predefined period of time, can indicate accelerated degradation of the VRM 221f and/or indicate instability in power supply.

Additionally, or alternatively, the set of VRM telemetry data 2056 can include output voltage(s) and/or output current(s). For instance, the VRM controller may report a balance condition between the output voltage(s), output current(s), and phase current(s), to a BMC (or embedded controller), via an I2C, PMBus, or Serial Voltage Identification Digital (SVID) interface. The telemetry collection engine 201 can collect the output voltage(s) and/or output current(s). A dramatic variation (e.g., over a time period) in the output voltage, the output voltage beyond a predefined voltage range, or current unbalance between phases can each indicate that the VRM is to fail.

Additionally, or alternatively, the set of VRM telemetry data 2056 can include a phase health condition (if applicable). Some digital VRM controller may possess a self-diagnosis capability and report a health condition or error indicator for each power supply phase. Such phase health condition(s) can be acquired using the telemetry collection engine 201.

In some embodiments, the one or more hardware components 221 can, additionally, or alternatively, include a network interface controller (NIC), a memory controller, and/or a dual in-line memory module (DIMM). A set of telemetry data associated with the NIC may be collected, a set of telemetry data associated with the memory controller, and/or a set of telemetry data associated with the DIMM can be collected.

The set of telemetry data associated with the NIC can indicate or include counts of one or more types of errors (e.g., CRC error, packet loss rate), status of one or more links, queuing status, and/or temperatures associated with the NIC, and may be processed to predict network connection issues or hardware faults associated with the NIC. The set of telemetry data associated with the memory controller may include corrected or uncorrected errors (e.g., error correcting code error, “ECC error”), counts of channel errors, refresh rate, and errors associated with command or bus. Such set may be processed to indicate or predict a health condition of the memory controller. The set of telemetry data associated with the DIMM may include one or more values of a temperature read from a serial presence detect (SPD) hub (or a thermal sensor) of the DIMM and/or one or more values of voltage margin. Such set may be processed to indicate or predict a health condition of the DIMM.

In some embodiments, the telemetry collection engine 201 can dynamically adjust or modify a sampling/retrieving frequency for each type of telemetry data described above. In this way, the occurrences of false positives or false negatives for hardware malfunction prediction may be reduced. The sampling frequency can be determined and/or adjusted based on one or more properties of a corresponding hardware component (e.g., CPU, fan, etc.), a typical rate that a fault develops, and/or resource limitations of a firmware environment, etc. For example, a first frequency can be applied to collect values for parameters such as temperature or voltage that change relatively slowly, and a second frequency can be applied to collect one or more error counts, where the second frequency can be higher than the first frequency. Alternatively, the one or more error counts can be collected each time an error occurs. In some embodiments, telemetry data including the telemetry data 205 and/or any subsequent set of telemetry data (e.g., additional telemetry data), once collected, can be cached in a circular buffer 208 (see FIG. 2C) on a memory that stores SMM (or UEFI), for subsequent processing using the LADP engine 202. The circular buffer is so designed to balance between effectiveness and memory consumption.

Continuing with the non-limiting example above and now referring to FIG. 2C, the LADP engine 202 can process the telemetry data 205 to generate the set of LADP outputs 207. The LADP engine 202 can include, for instance, a statistical process control (SPC) engine 2021, a rule-based inference (RI) engine 2023, a machine learning (ML) engine 2025, a health score calculation engine 2027, and/or an alert generation engine 2029.

In various implementations, the SPC engine 2021 can be configured to process the telemetry data 205 (or a portion thereof), to generate one or more SPC outputs 2022 indicating whether one or more hardware components of the server system are in a healthy condition or not.

As a working example, the telemetry data 205 can include a set of the telemetry data that is associated with the CPU 221a (or a portion thereof, such as a temperature value, or a temperature sequence, for a temperature of the CPU 221a), a set of telemetry data that is associated with the VRM 221f (or a portion thereof, such as an output voltage of the VRM 221f), a set of telemetry data that is associated with the SSD 221b (or a portion thereof, such as an uncorrectable bit error rate of the SSD 221b), and/or a set of telemetry data that is associated with the fan 221e (or a portion thereof, such as a RPM of the fan 221e).

In the working example above, in response to detecting presence of the temperature value for the temperature of the CPU 221a in the telemetry data 205, the SPC engine 2021 can retrieve one or more temperature thresholds (e.g., a lower temperature limit for CPU 221a and/or an upper temperature limit for CPU 221a) from one or more databases (e.g., including a temperature threshold database that stores temperature thresholds for one or more hardware components of the server system, see “250” in FIG. 2E). The SPC engine 2021 can compare the temperature value in the telemetry data 205 that is associated with the CPU 221a to the one or more temperature thresholds (e.g., associated with the CPU 221a), to generate a first SPC output. The first SPC output, of the one or more SPC outputs 2022, may indicate whether the CPU 221a is in a healthy condition or not (e.g., over heat).

Additionally, or alternatively, continuing with the working example above, in response to detecting presence of output voltage of the VRM 221f in the set of telemetry data 205, the SPC engine 2021 can retrieve one or more output voltage thresholds (e.g., a lower output voltage for the VRM 221f and/or an upper output voltage for the VRM 221f) from the one or more databases 250 (e.g., including a voltage threshold database that stores voltage thresholds for one or more hardware components of the server system). The SPC engine 2021 can compare the output voltage in the telemetry data 205 that is associated with the VRM 221f to the one or more output voltage thresholds (e.g., associated with the VRM 221f), to generate a second SPC output. The second SPC output, of the one or more SPC outputs 2022, may indicate whether the VRM 221f is in a healthy condition or not (e.g., output an unstable output voltage, instead of a low and stable output voltage, for use by a processing unit such as GPU or CPU 221a).

Additionally, or alternatively, continuing with the working example above, in response to detecting presence of uncorrectable bit error rate of the SSD 221b in the set of telemetry data 205, the SPC engine 2021 can retrieve a maximal uncorrectable bit error rate from the one or more databases 250 (e.g., including an error rate database that stores maximally allowable error rate(s) for one or more hardware components of the server system). The SPC engine 2021 can compare the uncorrectable bit error rate of the SSD 221b to the maximal uncorrectable bit error rate, to generate a third SPC output. The third SPC output, of the one or more SPC outputs 2022, may indicate whether the SSD 221b is in a healthy condition or not (e.g., bad connection to the SSD 221b).

Additionally, or alternatively, continuing with the working example above, in response to detecting presence of RPM of the fan 221e in the set of telemetry data 205, the SPC engine 2021 can retrieve one or more RPM thresholds (e.g., a lower RPM limit for the fan 221e and/or an upper RPM limit for the fan 221e) from the one or more databases 250 (e.g., including a RPM threshold database that stores RPM thresholds for one or more hardware components of the server system). The SPC engine 2021 can compare the RPM limit for the fan 221e to the one or more RPM thresholds, to generate a fourth SPC output. The fourth SPC output, of the one or more SPC outputs 2022, may indicate whether the fan 221e is in a healthy condition or not (e.g., ambient temperature of an environment of the server system exceeding an upper temperature limit).

In some implementations, the SPC engine 2021 can determine one or more of the aforementioned thresholds (e.g., temperature threshold(s), output voltage threshold(s), error rate limit(s), RPM threshold(s), etc.) or related average value(s) based on properties of one or more corresponding hardware components (CPU 221a, SSD 221b, fan 221e, VRM 221f) of the server system, and/or historical data showing a range of normal working properties for the one or more hardware components. Additionally, or alternatively, the SPC engine 2021 can determine one or more of the thresholds (or the related average values) based on telemetry data collected in association with the server system during a predetermined period of time during which the server system operates. In some implementations, the SPC engine 2021 can dynamically adjust or modify the one or more thresholds (or the related average values) associated with the one or more hardware components (e.g., CPU 221a, etc.) based on operation conditions (e.g., load, environmental temperature) of the server system and/or operation time (e.g., degradation effect) of the corresponding hardware component(s).

For example, the SPC engine 2021 can determine one or more temperature thresholds based on properties of the CPU 221a, and/or based on historical data showing a range of normal working temperatures for the CPU 221a. Additionally, or alternatively, the SPC engine 2021 can determine the one or more temperature thresholds based on telemetry data collected in association with the CPU 221a during a predetermined period of time during which the server system operates. In some implementations, the SPC engine 2021 can dynamically adjust or modify the one or more temperature thresholds associated with the CPU 221a based on operation conditions (e.g., load, environmental temperature) of the server system and/or operation time (e.g., degradation effect) of the CPU 221a. Similar descriptions for other hardware components, such as the fan 221e are omitted herein, for the sake of brevity.

In some implementations, the telemetry data 205 can include telemetry data collected at a specific date and time. In some other implementations, the set of telemetry data 205 can include telemetry data collected over a period of time (may also be referred to as “a time series of telemetry data”, or “a time sequence of telemetry data”). As a non-limiting example, the telemetry data 205 can include a sequence of temperature values of the CPU 221a collected over a period of time, a sequence of output voltages of the VRM 221f over the same period of time, a sequence of uncorrectable bit error rates of the SSD 221b over the same period of time, and/or a sequence of RPMs of the fan 221e over the same period of time. In some embodiments, the SPC engine 2021 can process one or more of the sequences (e.g., the sequence of temperature values), to determine an average, to determine a deviation, and/or to detect a sudden change/deviation.

For example, the SPC engine 2021 can determine a moving average for a sequence of temperature values for the CPU 221a, using a statistical method of exponentially weighted moving average (EWMA) or a statistical method of simple moving average (SMA). In this example, the SPC engine 2021 can, for a respective temperature value in the sequence of temperature values, determine a deviation (e.g., Z-score) between an average temperature value and the respective temperature value. For instance, if multiple temperature values for the CPU 221a in the sequence of temperature values for the CPU 221a continuously exceed a Z-score threshold (e.g., 3σ), the SPC engine 2021 can determine that the CPU 221a is in an abnormal condition.

Additionally, or alternatively, the SPC engine 2021 can detect small but continuous deviation in the temperature value associated with the CPU 221a, by generating a cumulative sum control chart based on the sequence of temperature values for the CPU 221a. Additionally, or alternatively, the SPC engine 2021 can detect a dramatic change in one or more statistical properties (e.g., average value and/or variance) of the temperature value associated with the CPU 221a, using a change point detection algorithm. The statistical methods or approaches (e.g., EWMA, change point detection, etc.) discussed herein involve relatively simple calculations. As a result, the SPC engine 2021 is a lightweight engine suitable for implementation at firmware of the server system and for efficiently extracting desired values (e.g., average) from corresponding telemetry data which may be noisy prior to any data processing.

In various implementations, the LADP engine 202 can include the rule-based inference (RI) engine 2023. The rule-based inference (RI) engine 2023 may apply one or more rules to the set of telemetry data 205 (or a portion thereof, or one or more values derived from the set of telemetry data 205), to generate a predictive output 2024. The predictive output 2024 can include one or more health scores and/or a predictive alert message. For example, the set of telemetry data 205 may include (or otherwise indicate) a corrected error rate for a CPU core (“X”) that exceeds a corrected error rate threshold (“A”), a temperature of the CPU core (“X”) that exceeds a CPU core temperature threshold (“B”). In this example, the rule-based inference engine 2023 can process the corrected error rate for a CPU core (“X”) and the temperature of the CPU core (“X”), using a first set of rules, to generate the predictive output 2024, e.g., a health score for the CPU core (“X”). The first set of rules can include, for instance, IF (CPU_Core_X_Corrected_Error_Rate > Threshold_A FOR Duration_T1) AND (CPU_Core_X_Temperature > Threshold_B) THEN Health_Score_CPU_Core_X = Penalty_1. In this case, the health score for the CPU core (“X”) can be “Penalty_1.”

As another example, the telemetry data 205 may include (or otherwise indicate) a used percentage for a NVMe SSD which exceeds a used percentage threshold (e.g., “95%”), and/or a percentage of spare memory available for replacing bad or failing blocks on the NVMe SSD to be less than 5%. In this example, the rule-based inference engine 2023 can process the used percentage and the percentage of spare memory available for replacing bad or failing blocks on the NVMe SSD, using a second set of rules, to generate the predictive output 2024. The second set of rules can be, for instance, IF (NVMe_Percentage_Used > 95%) AND (NVMe_Available_Spare < 5%) THEN Generate_Predictive_Alert (NVMe_Wearout, High_Severity). The predictive output 2024 in this example can be a predictive alert message showing the following text: “NVMe_Wearout, High_Severity”. The predictive alert message indicates that the NVMe SSD is wearout and the severity level is “High_Severity”. The presence of “High_Severity” in the predictive alert message indicates that immediate mitigation measure (e.g., replacement of the NVMe SSD) is desired and/or immediate alert reporting to a system administrator is required.

As a further example, the telemetry data 205 may include (or otherwise indicate) an output voltage of a PSU (which is approximately 11.4V for a duration of T2, below a required output voltage of 12V). In this example, the rule-based inference engine 2023 can process the output voltage and the temperature of the CPU core (“X”), using a third set of rules, to generate the predictive output 2024. The third set of rules can be, for instance, “IF (PSU1_Output_Voltage_12V < 11.4V FOR Duration_T2) AND (PSU_Redundancy_Enabled = TRUE) THEN Generate_Predictive_Alert (PSU1_Undervoltage, Medium_Severity).” The predictive output 2024 in this example can be a predictive alert message: “PSU1_Undervoltage, Medium_Severity,” indicating that the PSU is undervoltage and the severity level is “Medium_Severity”. The presence of “Medium_Severity” may indicate that a mitigation action needs to be performed with a predefined period.

In various implementations, the machine learning engine 2025 can be in communication with one or more machine learning (ML) models 211. In some implementations, the one or more ML models 211 can be, or can include, a micro-ML model or a tiny ML model (e.g., having parameters less than 1 million), for implementation of the LADP engine 202 at the firmware for which limited memory space is allocated. In various implementations, the telemetry data from multiple hardware components can be processed as input, using the one or more ML models, to generate one or more ML model outputs 2026. The one or more ML model outputs 2026 can indicate, for each of one or more hardware components of the server system, a corresponding health condition. The one or more ML model outputs 2026 can include or indicate, for instance, a classification result, a remaining life for a hardware component, whether an anomaly is detected, a probability of hardware malfunction, one or more health scores, etc. Descriptions of the one or more ML model outputs 2026 are not intended to be limiting.

In some implementations, the one or more ML models 211 can include, for instance, a decision tree model, or a random forests model, to predict whether a hardware component is in a health condition, or to predict a remaining life for the hardware component. The decision tree model or the random forests model can be lightweight. Additionally or alternatively, the one or more ML models 211 can include a support vector machine (SVM) classifier trained to classify a health condition for one or more hardware components of the server system, from a plurality of predetermined health condition classifications. In some implementations, the plurality of predetermined health condition classifications can include two classifications: “healthy” and “not healthy”. In some implementations, the plurality of predetermined health condition classifications (e.g., for a VRM) can include more than two classifications: “healthy”, “undervoltage” and “overvoltage”. Descriptions of the plurality of predetermined health condition classifications are not intended to be limiting.

Additionally or alternatively, the one or more ML models 211 can include one or more autoencoders for detecting one or more types of anomalies. An autoencoder is an unsupervised neural network model and can be trained offline to learn whether any data point (e.g., temperature value) is abnormal. Additionally or alternatively, the one or more ML models 211 can include an isolation forest model which is unsupervised and trained for efficiently detecting anomalies. For instance, the isolation forest model can determine a temperature value being an abnormal point based on the temperature value possessing a relatively short average path length. Additionally or alternatively, the one or more ML models 211 can include one or more Bayesian networks for predicting a probability of hardware fault and/or fault diagnosis.

In some implementations, the one or more ML models 211 can be pre-trained at a high performance computing platform (e.g., a server), using a large amount of historical telemetry data (e.g., including both telemetry data of different hardware components under a normal operating condition and telemetry data of the hardware components under an abnormal operating condition). The pre-trained one or more ML models can be, for instance, pruned or distilled, to generate the one or more ML models 211 for implementation at the firmware level. Additionally or alternatively, quantization can be applied to a pre-trained ML model, to generate a ML model for implementation at firmware.

In some implementations, the one or more ML models 211 can include a single ML model used for processing, as input, telemetry data from multiple hardware components. Processing of the telemetry data from multiple hardware components as input, using the single ML model (or using the one or more ML models 211), can result in one or more model outputs (e.g., ML model output 2026). In some embodiments, one or more health scores can be determined based on the one or more model outputs. For example, the one or more health scores can include a first health score indicating a health condition of a CPU (e.g., CPU 221a), a second health score indicating a health condition of a NVMe SSD, and a third health score indicating a health condition of a PSU. In some other embodiments, the one or more health scores can be generated or modified based on the aforementioned predictive output 2024 and/or the SPC output(s) 2022 of the SPC engine 2021, which are acquired based on processing the telemetry data 205 collected from multiple hardware components and/or collected from a BMC (and/or EC) that is in communication with the multiple hardware components.

As a working example, the single ML model can be used to process a telemetry data input (that is derived from a CPU temperature, a VRM current value, and a RPM of a fan), to generate one or more ML outputs indicating whether the server system has a risk of over heat and/or whether a cooling effect of the fan is effective. As another working example, the single ML model can be used to process a telemetry data input (that is derived from a temperature of a SSD and a RPM of a fan adjacent to the SSD), to generate one or more ML outputs from which an alert message is generated. The alert message can indicate that the SSD is predicted to be over heated at a future moment T. In this way, the overheat issue of the SSD can be addressed at an early stage where the overheat does not actually occur, rather than at a late stage where the SSD malfunctions.

In various implementations, the LADP engine 202 can include the health score calculation engine 2027, and the health score calculation engine 2027 can generate a health score output 2028 to include one or more health scores calculated or determined based on the aforementioned one or more SPC outputs 2022, the aforementioned predictive output 2024, and/or the aforementioned one or more ML model outputs 2026. For example, the health score calculation engine 2027 can calculate a first health score for the CPU 221a, based on a first SPC output (of the one or more SPC outputs 2022) that indicates whether the CPU 221a is in health condition, based on the predictive output 2024 that predicts a health score for the CPU 221a by applying one or more rules to the set of CPU telemetry data 2051, and/or based on a first ML model output (of the one or more ML model outputs 2026) that indicates a health condition of the CPU 221a. The first health score for the CPU 221a can be, for instance, a weighted sum of the first SPC output, the predictive output 2024, and the first ML model output.

In various implementations, the LADP engine 202 can include the alert generation engine 2029, and the alert generation engine 2029 can determine whether or not to generate an alert message based on the health score output 2028. For example, the alert generation engine 2029 can be in communication with the RI engine 2023 to determine whether the predictive output 2024 of the RI engine 2023 includes an alert and/or whether to modify the alert generated by the RI engine 2023 (e.g., to include additional alert information based on the SPC output 2022, the ML model output(s) 2026, the health score output 2028, etc.). In some embodiments, in response to determining that a health score (of the one or more health scores in the health score output 2028) that corresponds to a hardware component (e.g., CPU) fails to satisfy a corresponding health score threshold, the alert generation engine 2029 can generate an alert 2029a (e.g., an alert message) alerting (or predicting) a hardware malfunction of the hardware component (e.g., CPU) of the server system. The alert 2029a can include an identifier of the hardware component determined (or predicted) to be not in a healthy condition, a type of malfunction determined or predicted for the hardware component, a level of malfunction (e.g., high severity, medium severity, low severity, etc.) determined or predicted for the hardware component, and/or related telemetry data (or a summary thereof) from which the malfunction is determined or predicted.

In some other embodiments, the alert generation engine 2029 can generate an alert message in response to the health score (e.g., reflected in the health score output 2028) that corresponds to the hardware component (e.g., CPU) fails to satisfy a corresponding health score threshold for a predetermined period of time (e.g., 5 seconds or any other applicable period). The health score threshold may also be referred to as “predictive failure threshold” and can be dynamically adjusted based on the type of the hardware component, the role of the hardware component in the server system, and/or historical malfunction data. For example, given a first hardware component playing a key role in the server system and a second hardware component playing a supplemental role in the server system, a first health score threshold can be assigned to the first hardware component and a second health score threshold can be assigned to the second hardware component, where the first health score threshold is lower than the second health score threshold. In some other embodiments, the alert generation engine 2029 can generate an alert message in response to the LADP engine 202 detecting an anomaly presenting a high risk to the server system. The anomaly can be detected, for instance, based on the one or more ML model outputs 2026.

FIG. 2D illustrates an example flowchart showing determination of mitigation action(s) using a PMA engine 203, according to one or more embodiments of the present disclosure. As shown in FIG. 2D, the PMA engine 203 can receive, from the LADP engine 202, the one or more LADP outputs 207 generated based on processing telemetry data (e.g., 205 in FIG. 2B~2C). In various implementations, the PMA engine 203 can generate a PMA output 209 based on the one or more LADP outputs 207, where the PMA output 209 can indicate the mitigation action(s) to be performed.

In some embodiments, the one or more LADP outputs 207 can indicate that a specific CPU core (or a specific pair of CPU cores, or a specific cluster of CPU cores) is going to malfunction (e.g., at a future time t) based on continuous corrected errors, extremely high temperature, or MCA data. In this case, the PMA output 209 of the PMA engine 203 can indicate one or more CPU malfunction mitigation actions for the specific CPU core (or the specific pair of CPU cores, etc.). In some embodiments, the one or more CPU malfunction mitigation actions may be performed the next time the server system is started.

In some embodiments, the one or more CPU malfunction mitigation actions can include, for instance, a first CPU malfunction mitigation action that modifies a table (e.g., an advanced configuration and power interface “ACPI” table) within firmware that describes hardware components (e.g., CPU) and related configurations. The first CPU malfunction mitigation action can modify the ACPI table to disable the aforementioned specific CPU core, so that the specific CPU core will not be recognized or used by an operating system of the server system. The ACPI table can be, for instance, a multiple APIC description table (MADT).

Additionally, or alternatively, in some embodiments, the one or more CPU malfunction mitigation actions can include a second CPU malfunction mitigation action that disables or isolate the specific CPU core by utilizing functions such as the Core Disable for Fault Resilient Boot (FRB) function to, e.g., write to a model-specific register (MSR) associated with the specific CPU core. Additionally, or alternatively, in some embodiments, the one or more CPU malfunction mitigation actions can include a third CPU malfunction mitigation action (to be executed in SMM) that transfers one or more tasks running on the specific CPU core to another CPU core in healthy condition, and/or a fourth CPU malfunction mitigation action that set the specific CPU core in a sleep state (e.g., a C-state, such as C1 to Cn, which represents an idle sleep state where processor clock is inactive). The sleep state of the specific CPU core results in a reduced power consumption.

Additionally, or alternatively, in some embodiments, the one or more CPU malfunction mitigation actions can include a fifth CPU malfunction mitigation action that modifies a cap for frequency and/or power. For example, the one or more LADP outputs 207 can indicate that the specific CPU core (or the specific pair of CPU cores) is unstable or overheat, or that a VRM in a proximity to (and supplies power to) the specific CPU core is unstable or overheat. In this example, the PMA engine 203 can write directly to one or more associated MSRs (e.g., a power limit register, a frequency control register), or can interact with a power management module (e.g., Intel SpeedStep, AMD Cool’n’Quiet) in system firmware, to reduce the maximum operating frequency of the CPU (or CPU core) or to reduce an upper limit of a thermal design power (TDP). In this way, the thermal stress and/or electrical stress of the hardware component (e.g., the CPU core) can be effectively reduced, so as to postpone malfunction of the hardware component.

In some embodiments, the one or more LADP outputs 207 may be generated during a UEFI POST or DXE phase, and may indicate that a PCIe device is going to malfunction (e.g., at a future time t) based on a large number of uncorrected errors reported by a PCIe card. In this case, the PMA output 209 of the PMA engine 203 can indicate one or more PCIe malfunction mitigation actions that prevent the initialization and enumeration of the PCIe device. For example, the one or more PCIe malfunction mitigation actions can include a first PCIe malfunction mitigation action that prevents the loading of Option ROM of the PCIe device or that prevents the loading of the UEFI driver (e.g., into memory). The one or more PCIe malfunction mitigation actions can, additionally or alternatively, include a second PCIe malfunction mitigation action that labels the PCIe device (or a PCIe slot of the PCIe device) in the ACPI table as “disabled”.

The first and/or second PCIe malfunction mitigation action can be performed, and by performing the first and/or second PCIe malfunction mitigation actions, failure or breakdown of the server system during a startup stage or an early running stage of the operating system caused by malfunction of the PCIe device may be avoided.

In some embodiments, the one or more LADP outputs 207 may indicate that a PCIe link associated with the PCIe device is unstable or the integrity of signal(s) transmitted over the PCIe link is poor. This may occur when there are frequent corrected errors for the PCIe link, or the PCIe cannot reach its maximal transmission rate or bandwidth. In this case, the PMA output 209 of the PMA engine 203 can indicate one or more PCIe link malfunction mitigation actions to be applied to UEFI configuration (or to be performed during execution of the SMM, if applicable). The one or more PCIe link malfunction mitigation actions can include, for instance, a first PCIe link malfunction mitigation action that mandatorily reduces a transmission rate of the PCIe link from Gen4 to Gen3, and/or a second PCIe link malfunction mitigation action that mandatorily reduces a transmission bandwidth of the PCIe link from x16 to x8. In this way, stable operation of the PCIe link may be ensured.

In some embodiments, the one or more LADP outputs 207 may indicate that a controller of the PCIe device shows abnormal behavior (e.g., response timeout, error in command execution) but has not become completely ineffective. In this case, the PMA output 209 of the PMA engine 203 can indicate a PCIe controller malfunction mitigation action that resets the controller for the PCIe device. The PMA output 209 may be processed, for instance, to generate a reset signal (e.g., function level reset “FLR”, or a lower-level reset signal, if applicable) that resets the controller for the PCIe device at the firmware level. In this way, the controller for the PCIe device may recover from a temporary error state.

In some embodiments, the one or more LADP outputs 207 may be generated during a UEFI POST or DXE phase, and may indicate that a storage device (e.g., NVMe SSD) is going to malfunction (e.g., at a future time). This may occur when the field of critical warning in S.M.A.R.T data in the NVMe report shows reduced reliability or “read-only mode”. In this case, the PMA output 209 of the PMA engine 203 can indicate one or more storage device malfunction mitigation actions that prevent the initialization and enumeration of the storage device. For example, the one or more storage device malfunction mitigation actions can include a first storage device malfunction mitigation action that prevents the loading of Option ROM of the storage device or that prevents the loading of the UEFI driver (e.g., into memory). The one or more storage device malfunction mitigation actions can, additionally or alternatively, include a second storage device malfunction mitigation action that labels the storage device (or a PCIe slot for the storage device) in the ACPI table as “disabled”.

The first and/or second storage device malfunction mitigation action can be performed, and by performing the first and/or second storage device malfunction mitigation actions, failure or breakdown of the server system during a startup stage or an early running stage of the operating system caused by malfunction of the storage device may be avoided.

In some embodiments, the one or more LADP outputs 207 may indicate that a controller of the storage device shows abnormal behavior (e.g., response timeout, error in command execution) but has not become completely ineffective. In this case, the PMA output 209 of the PMA engine 203 can indicate a storage device controller malfunction mitigation action that resets the controller for the storage device. The PMA output 209 may be processed, for instance, to generate a reset signal (e.g., function level reset “FLR”, or a lower-level reset signal, if applicable) that resets the controller for the storage device at the firmware level. In this way, the controller for the storage device may recover from a temporary error state.

In some embodiments, the server system may enable a redundant array of independent disks (RAID), and the one or more LADP outputs 207 may indicate that the NVMe driver for the storage device is going to malfunction. In this case, the PMA output 209 of the PMA engine 203 can be processed to generate a predictive message predicting malfunction of the NVMe driver. The PMA engine 203 can transmit the predictive message to a baseboard management controller (BMC) or to RAID management application embedded in the operating system. The BMC or the RAID management application can label the NVMe driver as “predictive failure,” and perform one or more actions. The one or more actions can include, for instance, automatically performing data reconstruction from the storage device (predicted to fail) to a hot spare (if applicable). The one or more actions can, additionally, or alternatively, include transmitting the predictive message (or a modified version thereof) to a system administrator of the server system.

In some embodiments, the one or more LADP outputs 207 may indicate that an active PSU is going to malfunction. This may occur when the output voltage of the active PSU continues to remain too high or too low, or when an internal temperature of the active PSU is abnormal, or when the PMBus reports severe warning. In this case, for a server system having one or more spare PSUs, the PMA output 209 of the PMA engine 203 can indicate a first PSU malfunction mitigation action that switches a load of the active PSU (predicted to malfunction) to a spare PSU in a healthy condition. Such PSU malfunction mitigation action can be performed via interaction with the BMC or an embedded controller (EC) that directly manages redundancy and switching logics of PSUs. Switching the load of the active PSU to the spare PSU may be performed before the cut-off of the server system caused by the malfunction of the active PSU, to ensure continuous operation of the server system.

In some embodiments, the one or more LADP outputs 207 may indicate that the performance of a PSU is degrading but the PSU does not need to be immediately replaced. In this case, if the server system includes multiple PSUs that support dynamic load balancing, the PMA output 209 of the PMA engine 203 can indicate a second PSU malfunction mitigation action that that transfers a portion of a current load of the PSU (that is detected to have degraded performance) to other PSU(s). This may elongate a life term of the PSU that is predicted to malfunction, or postpone the occurrence of the malfunction of such PSU.

In some embodiments, the one or more LADP outputs 207 may indicate that a fan of the server system is going to malfunction. This may occur when a RPM of the fan continues to be much lower than a target RPM, when a pulse width modulation (PWM) signal does not match a RPM response, or when a motor current is abnormal. In this case, the PMA output 209 of the PMA engine 203 can indicate a first fan malfunction mitigation action that temporarily (e.g., for a predefined period of time) increases a speed of other fan(s) in proximity of the fan predicted to malfunction, or that adjusts a pressure-volume flow rate (PQ) curve for fans of the server system.

In some embodiments, the one or more LADP outputs 207 may indicate that a fan in a proximity to one or more key components (e.g., CPU, GPU, or memory) of the server system is going to malfunction. In this case, if increasing RPM(s) of one or more additional fans cannot fully compensate for the need of the server system for heat dissipation, the PMA output 209 of the PMA engine 203 can indicate a second fan malfunction mitigation action that restrict performance of the one or more key components. For example, the second fan malfunction mitigation action can reduce the maximal frequency or the upper limit of the power consumption of the CPU or GPU. In this way, the heat generated by the one or more key components such as CPU and GPU can be reduced, which helps the server system to operate within an appropriate temperature range.

In some embodiments, the one or more LADP outputs 207 may indicate that a VRM of the server system is going to malfunction. In this case, if a controller of the VRM allows fine-grained control via firmware interface (e.g., sending commands via I2C or PMBus, or expansion function via the SVID protocol), the PMA output 209 of the PMA engine 203 can indicate a first VRM malfunction mitigation action that adjusts the number of phases of the VRM. For example, the first VRM malfunction mitigation action may correspond to closing a phase at issue if the VRM supports phase redundancy or dynamic phase shedding, or adjusting current balance between different phases. In this way, the power supply can be stabilized. This is a mitigation action that requires close cooperation between the VRM hardware and the firmware interface.

In some embodiments, the one or more LADP outputs 207 may indicate that a hardware component of the server system will malfunction to affect the quality or stability of the power supplied by the VRM to the hardware component. In this case, the PMA output 209 of the PMA engine 203 can indicate a second VRM malfunction mitigation action that restricts performance (or reduces frequency) of the hardware component (e.g., specific core of a CPU, memory controller, or Dual In-line Memory Module “DIMM”). In this way, the load and electrical pressure of the VRM can be lowered, so as to prevent broader system malfunction caused by the power supply issue.

In some embodiments, one or more of the aforementioned mitigation actions can be selectively disabled or enabled by a system administrator of the server system. In some embodiments, a plurality of mitigation actions, from the aforementioned mitigation actions, can be selected to perform, for example, when multiple hardware components (e.g., CPU, storage device, fan, PSU, and/or VRM, etc.) are predicted to malfunction. In this case, an order of the plurality of mitigation actions to be performed can be determined based on one or more order-prioritizing rules. The one or more order-prioritizing rules can include a first rule that prioritizes a mitigation action (e.g., throttling that prevents overheat) that ensures basic operation of the server system, or a second rule that prioritizes a mitigation action (e.g., switching PSU) that ensures data safety.

FIG. 2E illustrates an example flowchart showing recording and reporting one or more predictive malfunctions using a SLC engine 204, according to one or more embodiments of the present disclosure. As shown in FIG. 2E, the SLC engine 204 can generate an entry 291 based on the one or more LADP outputs 207 that predict whether one or more hardware components of the server system to malfunction and/or based on the PMA output 209 that indicates whether one or more mitigation actions 290 need to be performed. In some embodiments, the entry 291 may be modified to include descriptions of the one or more mitigation actions once the one or more mitigation actions are performed.

In some embodiments, the SLC engine 204 can generate the entry 291 in response to the one or more LADP outputs 207 predicting at least one hardware component (e.g., a first hardware component) of the server system to malfunction. As a working example, the SLC engine 204 can generate the entry 291 based on the one or more LADP outputs 207 (e.g., an alert message derived from the one or more LADP outputs 207), where the generated entry 291 can include an identifier (e.g., name, model, etc.) of the first hardware component (e.g., CPU 221a), a type of the malfunction of the first hardware component, and/or a time predicted for the first hardware component to malfunction. In some embodiments, the SLC engine 204 can generate (or modify) the entry 291 based on the PMA output 209 and based on the one or more LADP outputs 207. Continuing with the working example above, the generated entry 291 can further include one or more mitigation actions determined using the PMA engine 203, whether the one or more mitigation actions are performed, and/or a date and time each of the one or more mitigation actions is performed. The generated entry 291 may include other information, such as a health condition for one or more hardware components that are in a proximity to the first hardware component. The present disclosure is not intended to be limiting.

In various implementations, the entry generated using the SLC engine 204 may be stored in a non-volatile storage region of a main board or a motherboard. The non-volatile storage region can be a part of a serial peripheral interface (SPI) flash, independent of a memory (e.g., NOR flash chip) storing BIOS/UEFI firmware and independent of the memory (e.g., a storage drive or random access memory) used for storing or loading the operating system of the server system. The storage of entries generated using the SLC engine 204 in the above-described non-volatile storage region can ensure the persistence of data storage and ensure the accessibility of such entries when the server system experiences several faults (e.g., failure to load the operating system).

In some embodiments, when the non-volatile storage region is full, the non-volatile storage region can be managed in an old-entry-overwritten-when-full manner where when the non-volatile storage region is full, the oldest entry stored in the non-volatile storage region is overwritten by a latest entry generated using the SLC engine 204. In some embodiments, one or more entries stored in the non-volatile storage region can be validated or encrypted to prevent unauthorized modification (or changes made by accident) to content of the one or more entries. For example, access to the non-volatile storage region may be controlled or restricted by enabling access for only personnel or application(s) that is authorized by SMM, UEFI driver, or BMC.

As a non-limiting example, referring to FIG. 2F, an example entry 206 generated using the SLC engine 204 can include a time stamp 2061 recording a date and/or time associated with an event corresponding to a predicted malfunction of a particular hardware component, a type 2062 of the event, an identifier 2063 for the particular hardware component, a prediction description 2064 derived from the LADP output(s) 207, a description 2065 of a mitigation action determined from the PMA output 209, a severity level 2066 of the predicted malfunction, and/or other metadata associated with the event. The other metadata can include, for instance, a date or time the determined mitigation action is performed, a place the mitigation action is performed, and/or a condition (e.g., a health score) of the particular hardware component after performance of the mitigation action. Additional entry (e.g., 216) can be similarly generated using the SLC engine 204, and repeated descriptions are omitted herein.

The first time stamp 2061 can be, for instance, a date and/or time a predictive alert message is derived from the LADP output(s) 207 that predicts the particular hardware component (e.g., CPU 221a) to malfunction. The type 2062 of the event can be, for instance, generation of the predictive alert message, execution of a mitigation action, detection of a health score fail to satisfy a health score threshold, etc. The identifier 2063 for the particular hardware component can be a name or an ID of the particular hardware component, such as CPU0_Core1, NVMe_Slot 2, PSU1, FAN-SYS3, VRM_CPU0, etc. The prediction description 2064 derived from the LADP output(s) 207 can include, for instance, a health score for the particular hardware component, a predicted type of malfunction for the particular hardware component, and/or a description of an abnormal mode. The description 2065 of the mitigation action determined from the PMA output 209 can include, for instance, prohibition of the CPU core, isolation of PCIe device(s), or switching PSU1 to PSU2, etc. The severity level 2066 of the predicted malfunction can be, for instance, moderate, medium, severe, etc. The metadata associated with the event can include, for instance, an image of the particular hardware component, a snapshot of telemetry data, etc.

Referring again to FIG. 2E, in some embodiments, the SLC engine 204 can transmit a predictive alert message 281 (which can be derived from the LADP output(s) 207 that predicts the particular hardware component to malfunction) to a BMC 275. The SLC engine 204 can transmit the predictive alert message to the BMC 275 via a communication bus of the server system, in response to the generation of the predictive alert message. The communication bus can be, for instance, a low pin count (LPC) link, an Inter-Integrated Circuit (I2C) link, a system management bus (SMBus) link, a platform environment control interface (PECI) link, etc.

In some embodiments, additionally or alternatively, the SLC engine 204 can transmit a mitigation action message 283 describing or indicating one or more mitigation actions to a BMC 275. The SLC engine 204 can transmit the mitigation action message describing or indicating the one or more mitigation actions to the BMC 275, in response to completion of performance of the one or more mitigation actions.

In some embodiments, the BMC 275 can store information derived from the predictive alert message 281 and/or the mitigation action message 283 in a system event log (SEL) 2751 of the BMC 275. In this way, a system administrator can access (e.g., remotely) the SEL 2751 via an out-of-band management interface (e.g., an intelligent platform management interface or a Redfish API), to learn malfunction(s) predicted using the disclosed firmware system and the mitigation action(s) performed to prevent or mitigate the predicted malfunction(s). In some embodiments, the BMC 275 can generate one or more messages 287 or signals based on the predictive alert message 281 and/or the mitigation action message 283. The one or more messages 285 can be an email or a notification (e.g., Simple Network Management Protocol trap - “SNMP” trap), e.g., transmitted to an end user (e.g., the system administrator). In some embodiments, the BMC 275 can execute one or more management operations to mitigate the predicted malfunction(s).

In some embodiments, the LADP engine 202, the PMA engine 203, and/or the SLC engine 204 can be part of the SMM which is an operating mode often included in firmware of a computing system (e.g., server system). In some embodiments, the one or more LADP outputs 207 (or a portion thereof) generated using the LADP engine 202 may be transmitted to the BMC 275, and the BMC 275 may process the one or more LADP outputs 207 (or a portion thereof) and/or one or more internal rules, to determine one or more of the mitigation actions 290. For example, the health score output 2028 and/or the alert 2029a may be transmitted to the BMC 275, and the BMC 275 may determine one or more mitigation actions based on the health score output 2028 and/or the alert 2029a. By using the BMC 275 to determine the one or more mitigation actions 290 (or a portion thereof), such as switching the current PSU to a spare PSU, adjusting speed of a system fan, issuing a remote warning, the memory resources needed by the SMM to include the PMA engine 203 and/or the SLC engine 204 may be reduced.

Alternatively, by including the PMA engine 203 and/or the SLC engine 204 in the SMM, transmission time otherwise needed to transmit the one or more LADP outputs 207 from the LADP engine 202 of the SMM to the BMC 275 may be saved, and the SMM may provide easier and greater control of status of one or more CPUs and/or one or more PCIe devices than the BMC 275. For example, the implementation of the PMA engine 203 and/or the SLC engine 204 in the SMM may facilitate performance of mitigation actions such as disabling a CPU core that is predicted to malfunction, adjusting a frequency of the CPU core that is predicted to malfunction, or directly controlling a phase of the VRM. It is understood that the various engines disclosed in the present disclosure can also be implemented in a chip independent of the CPU and/or independent of the operating system.

In some embodiments, the SLC engine 204 can generate and/or transmit one or more additional messages to an operating system (e.g., “133” in FIG. 1) of the server system, e.g., via an Advanced Configuration and Power Interface (ACPI), via a notify mechanism, or using Windows SMM Security Mitigation Table (WSMT). The one or more additional messages can include, for instance, a description of a health condition of one or more hardware components and/or mitigation action(s) performed by the firmware to address a predicted malfunction of the one or more hardware components (or a portion thereof).

In some implementations, the firmware (e.g., “131” in FIG. 1) of the server system can provide a group of UEFI runtime services that enable the operating system to access predicted malfunction content generated using the LADP engine 202 and/or using the PMA engine 203. Such content can include, for instance, the one or more health scores generated using the LADP engine 202, a list of predictive alert messages generated using the LADP engine 202, and/or a history of mitigation actions determined or executed using the PMA engine 203.

In some embodiments, the operating system can adjust resource management in response to receiving aforementioned one or more additional messages from the SLC engine 204, or in response to accessing the predicted malfunction content. For example, the operating system can pause or postpone assigning a task to a CPU core that is predicted to malfunction. As another example, the operating system can perform more frequent health condition check for storage devices that are predicted to be unstable. As a further example, the operating system can transmit a notification to an end user or a system administrator, via a graphical user interface (GUI) or via an event log.

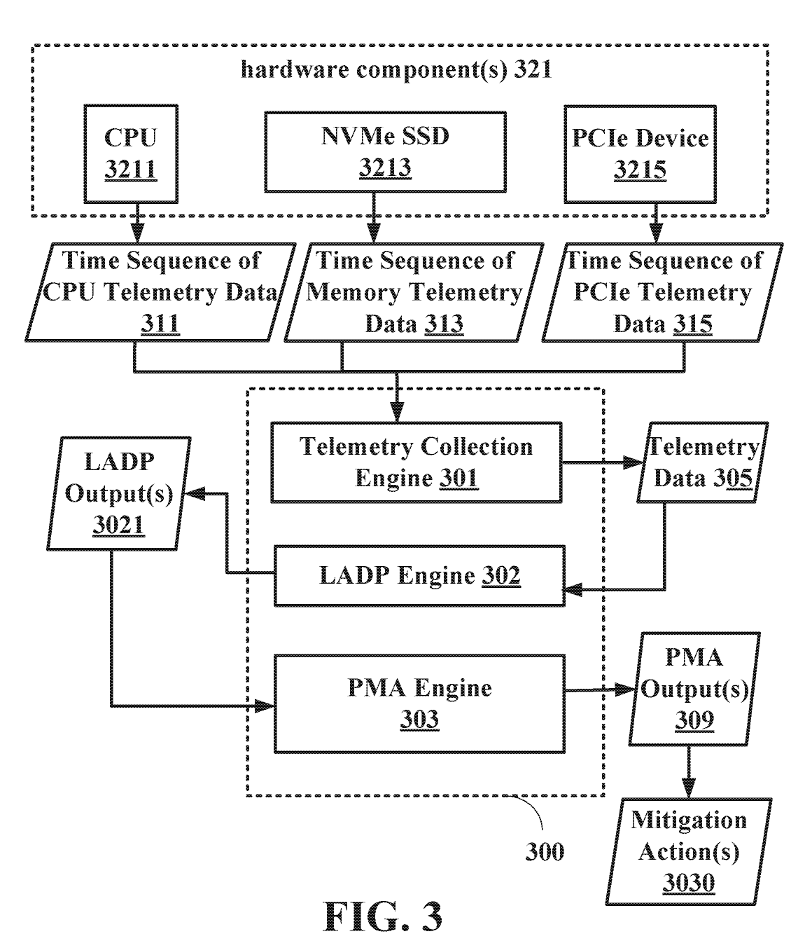

FIG. 3 illustrates an example system 300 for predictive management of core hardware components, according to one or more embodiments of the present disclosure. As shown in FIG. 3, the core hardware components 321 can include a CPU 3211, a SSD 3213 (e.g., a NVME SSD), and a PCIe device 3215. The example system 300 can include a telemetry collection engine 301, a LADP engine 302, and/or a PMA engine 303.

In some embodiments, the telemetry collection engine 301 can collect one or more time sequences of CPU telemetry data 311. The one or more time sequences of CPU telemetry data 311 can include, for instance, a first time sequence of CPU telemetry data reflecting a series of corrected errors for the CPU 3211 over a first time period. Additionally, or alternatively, the one or more time sequences of CPU telemetry data 311 can include a second time sequence of CPU telemetry data reflecting a series of uncorrected errors for the CPU 3211 over the first time period (or a different time period). The first or second time sequence of CPU telemetry data can be collected by the telemetry collection engine 301 from one or more MCA registers. Additionally, or alternatively, the one or more time sequences of CPU telemetry data 311 can include a third time sequence of CPU telemetry data reflecting a series of temperatures detected for the CPU 3211 over the first time period (or a different time period). The third time sequence of CPU telemetry data reflecting the series of temperatures can be collected by the telemetry collection engine 301 e.g., using a distributed temperature sensing (DTS) system having one or more temperature sensors.

In some embodiments, the telemetry collection engine 301 can collect one or more time sequences of SSD telemetry data 313. The one or more time sequences of SSD telemetry data 313 can include, for instance, a first time sequence of SSD telemetry data reflecting a variation in a percentage of available space for the SSD 3213 over the first time period (or a different time period). Additionally, or alternatively, the one or more time sequences of SSD telemetry data 313 can include a second time sequence of SSD telemetry data reflecting a variation in a total number of media and data integrity errors detected for the SSD 3213 over the first time period (or a different time period). Additionally, or alternatively, the one or more time sequences of SSD telemetry data 313 can include a third time sequence of SSD telemetry data reflecting a variation in a percentage of a life used for the SSD 3213 over the first time period (or a different time period). Additionally, or alternatively, the one or more time sequences of SSD telemetry data 313 can include a fourth time sequence of SSD telemetry data reflecting a variation in a temperature for the SSD 3213 over the first time period (or a different time period). Additionally, or alternatively, the one or more time sequences of SSD telemetry data 313 can include a fifth time sequence of SSD telemetry data reflecting a variation in a critical warning (where each bit corresponds to a critical warning type) for a state of the SSD 3213 over the first time period (or a different time period).

In some embodiments, the telemetry collection engine 301 can collect one or more time sequences of PCIe telemetry data 315. The one or more time sequences of PCIe telemetry data 315 can include, for instance, a first time sequence of PCIe telemetry data reflecting a series of corrected errors for the PCIe 3215 over the first time period (or a different time period). Additionally, or alternatively, the one or more time sequences of PCIe telemetry data 315 can include a second time sequence of PCIe telemetry data reflecting a series of uncorrected errors for the PCIe 3215 over the first time period (or a different time period). The first or second time sequence of PCIe telemetry data can be collected by the telemetry collection engine 301 from an AER register. The PCIe device 3215 can be a network interface controller, a RAID controller, or any other applicable device.

In some embodiments, the LADP engine 302 can process one or more of the time sequences of CPU telemetry data 311 (or one or more of the time sequences of SSD telemetry data 313, or one or more of the time sequences of PCIe telemetry data 315), using an EWMA approach, to determine a trend of telemetry data variation. In some embodiments, the LADP engine 302 can determine a deviation of a telemetry value associated with the CPU 3211 (or the SSD 3213, or the PCIe device 3215) from a corresponding mean value, based on calculation of a Z-score for the telemetry value associated with the CPU 3211 and/or based on historical data (e.g., collected during a total number of N previous times of initialization of the server system, or during a total of M hours of operation of the server system, where N and M are positive integers).

In some embodiments, the LADP engine 302 can process one or more of the time sequences of CPU telemetry data 311 generates a health score or an alert message based on one or more rules. For example, the LADP engine 302 can generate a health score for a CPU core by lowering a standard health score of the CPU core by a point of Z1 if the following rules/conditions are satisfied: (1) the corrected error rate of the CPU core is higher than an error rate threshold Y1 over the past one hour and (2) a temperature of the CPU core is higher than a temperature threshold Y2 for the past one hour. As another example, the LADP engine 302 can generate an alert message indicating a “severe” level of predicted malfunction if the following rules/conditions are satisfied: (i) the percentage of available space for the NVME driver is lower than 5% and (ii) the percentage of life used for the NVMe driver is higher than 90%.

In some embodiments, during a UEFI DXE phase, the telemetry collection engine 301 can collect a set of telemetry data (e.g., 305 in FIG. 3) in response to completion of initialization of the server system. The set of telemetry data can include the one or more time sequences of CPU telemetry data 311, the one or more of the time sequences of SSD telemetry data 313, the one or more of the time sequences of PCIe telemetry data 315, or any combination thereof. In this case, in response to receiving the set of telemetry data 305 from the telemetry collection engine 301, the LADP engine 302 can process the set of telemetry data 305, to generate one or more LADP outputs 3021. The one or more LADP outputs 3021 can include, for instance, the aforementioned trend of telemetry data variation, the deviation of the telemetry value associated with a hardware component (e.g., the CPU 3211, the SSD 3213, or the PCIe device 3215) from a corresponding mean value, a health score, an alert message, or any combination thereof.

In some embodiments, during running of the SMM, the telemetry collection engine 301 can collect a set of telemetry data periodically (e.g., every few minutes), and the LADP engine can process the set of telemetry data each time the set of telemetry data is received, to generate one or more LADP output predicting a malfunction of one or more hardware components (e.g., CPU 3211, SSD 3213, and/or PCIe device 3215).

In some embodiments, the PMA engine 303 can determine and/or execute one or more mitigation actions 3030 (e.g., based on the one or more LADP outputs 3021 generated during the UEFI DXE phase or during the SMM). During the UEFI DXE phase, if the one or more LADP outputs 3021 indicate that a NVMe driver or a PCIe device is in a poor health condition (e.g., S.M.A.R.T attributes indicate deadly error, or an AER indicator device fails to be initialized normally), the one or more mitigation actions 3030 can include prohibiting the loading of the UEFI driver of an associated device (e.g., the PCIe device). The one or more mitigation actions 3030 can, additionally, or alternatively, include: flagging the associated device (e.g., the NVMe driver or the PCIe device) as “disabled” or “non present” in the ACPI table, to prevent the operating system from attempting to access the associated device. This can prevent failure of the disclosed system in initialization and/or prevent system crash in an early stage.

During the running of the SMM, if the one or more LADP outputs 3021 indicate that a CPU core is in a poor health condition (e.g., bit error rate excessively high, health score drops dramatically), the one or more mitigation actions 3030 can include transmitting a high priority hardware error signal to the BMC and/or the operating system, e.g., via ACPI notification or service when UEFI runs. The one or more mitigation actions 3030 can, additionally, or alternatively, isolate the CPU core. The one or more mitigation actions 3030 can, additionally, or alternatively, flag the CPU core as “to be observed” or “predicted to fail” in the non-volatile memory of the firmware of the server system. In this way, the next time the server system starts, the PMA engine 303 can execute an action that prohibits the operation of the CPU core based on the flag.

During the UEFI DXE phase, if the one or more LADP outputs 3021 indicate that one or more S.M.A.R.T attributes of the NVMe driver indicates that the NVMe SSD is in a poor health condition (e.g., “degraded reliability” or “soon to enter read-only mode”, etc.), the one or more mitigation actions 3030 can include transmit a notification to the BMC for the BMC to trigger a higher level warning (e.g., to notify the system administrator), or for the BMC to notify the operating system to execute data backup or migration.

During the UEFI DXE phase, if the one or more LADP outputs 3021 indicate that a PCIe device continuously reports a large number of corrected errors, the one or more mitigation actions 3030 can include notifying the BMC to record one or more events corresponding to the corrected errors. In case the PCIe starts to report uncorrected errors and/or the PCIe link becomes unstable, the one or more mitigation actions 3030 can include notifying the operating system to reset the PCIe device or to reset the PCIe link.

One or more systems of the present disclosure (e.g., as depicted in FIG. 3) can be rule-based or statistics-based and therefore requires a relatively low consumption of computing and memory resources of the firmware. Further, one or more systems of the present disclosure may isolate a device predicted to malfunction before the operating system is initialized and may predict a trend of health condition development for the core hardware components of the server system. This allows the system administrator to be notified timely and therefore perform human intervention timely (if needed).

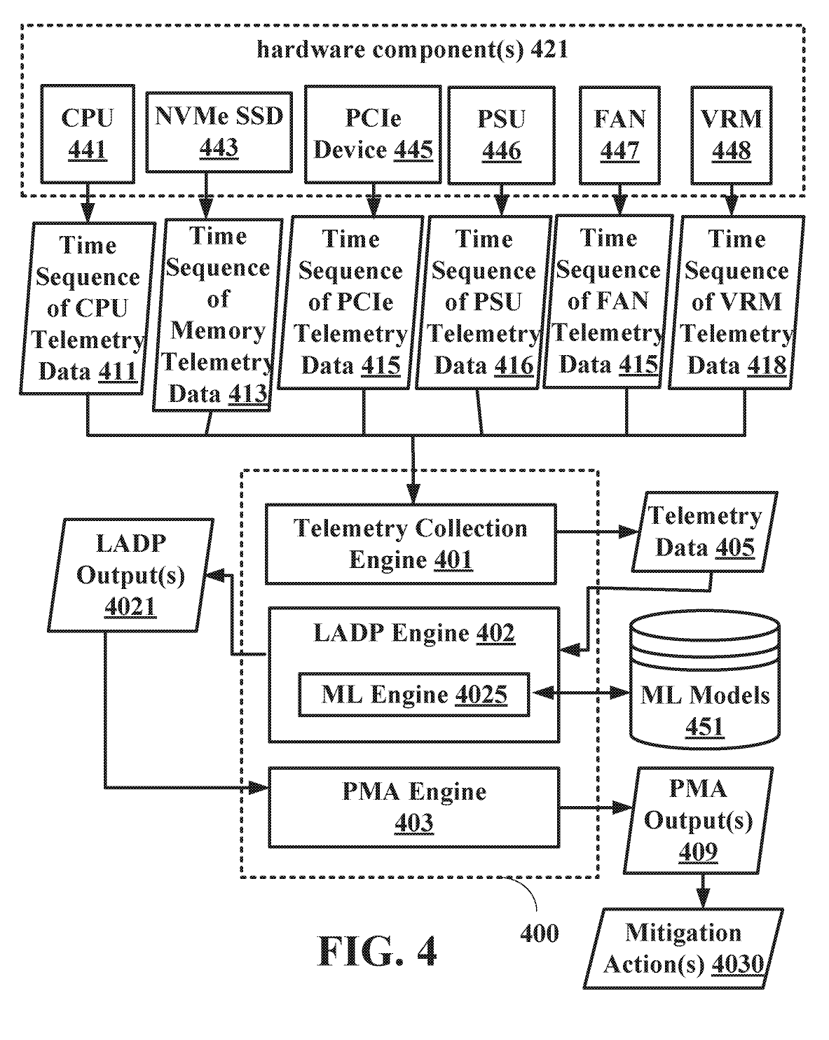

FIG. 4 illustrates another example system for predictive management of multiple hardware components, according to one or more embodiments of the present disclosure. As shown in FIG. 4, the multiple hardware components can include a CPU 441, a NVME SSD 443, a PCIe device 445, a PSU 446, a system fan 447, and a VRM 448. The example system 400 can include a telemetry collection engine 401, a LADP engine 402, and/or a PMA engine 403.

In some embodiments, the telemetry collection engine 401 can collect a set of telemetry data associated with multiple hardware components of the server system.

For example, in some embodiments, the telemetry collection engine 401 can collect one or more time sequences of CPU telemetry data 411. The one or more time sequences of CPU telemetry data 411 can include, for instance, a first time sequence of CPU telemetry data reflecting a series of corrected errors for the CPU 441 over a first time period. Additionally, or alternatively, the one or more time sequences of CPU telemetry data 411 can include a second time sequence of CPU telemetry data reflecting a series of uncorrected errors for the CPU 441 over the first time period (or a different time period). The first or second time sequence of CPU telemetry data can be collected by the telemetry collection engine 401 from one or more MCA registers. Additionally, or alternatively, the one or more time sequences of CPU telemetry data 411 can include a third time sequence of CPU telemetry data reflecting a series of temperatures detected for the CPU 441 over the first time period (or a different time period). The third time sequence of CPU telemetry data reflecting the series of temperatures can be collected by the telemetry collection engine 401 e.g., using a distributed temperature sensing (DTS) system having one or more temperature sensors.

In some embodiments, additionally, or alternatively, the telemetry collection engine 401 can collect one or more time sequences of SSD telemetry data 413. The one or more time sequences of SSD telemetry data 413 can include, for instance, a first time sequence of SSD telemetry data reflecting a variation in a percentage of available space for the SSD 443 over the first time period (or a different time period). Additionally, or alternatively, the one or more time sequences of SSD telemetry data 413 can include a second time sequence of SSD telemetry data reflecting a variation in a total number of media and data integrity errors detected for the SSD 443 over the first time period (or a different time period). Additionally, or alternatively, the one or more time sequences of SSD telemetry data 413 can include a third time sequence of SSD telemetry data reflecting a variation in a percentage of a life used for the SSD 443 over the first time period (or a different time period). Additionally, or alternatively, the one or more time sequences of SSD telemetry data 413 can include a fourth time sequence of SSD telemetry data reflecting a variation in a temperature for the SSD 443 over the first time period (or a different time period). Additionally, or alternatively, the one or more time sequences of SSD telemetry data 413 can include a fifth time sequence of SSD telemetry data reflecting a variation in a critical warning (where each bit corresponds to a critical warning type) for a state of the SSD 443 over the first time period (or a different time period).

In some embodiments, additionally, or alternatively, the telemetry collection engine 401 can collect one or more time sequences of PCIe telemetry data 415. The one or more time sequences of PCIe telemetry data 415 can include, for instance, a first time sequence of PCIe telemetry data reflecting a series of corrected errors for the PCIe 445 over the first time period (or a different time period). Additionally, or alternatively, the one or more time sequences of PCIe telemetry data 415 can include a second time sequence of PCIe telemetry data reflecting a series of uncorrected errors for the PCIe 445 over the first time period (or a different time period). The first or second time sequence of CPU telemetry data can be collected by the telemetry collection engine 401 from an AER register. The PCIe device 445 can be a network interface controller, a RAID controller, or any other applicable device.

In some embodiments, additionally, or alternatively, the telemetry collection engine 401 can collect one or more time sequences of PSU telemetry data 416. The one or more time sequences of PSU telemetry data 416 can include, for instance, a first time sequence of input voltages over the first time period (or a different time period), and/or a second time sequence of output voltages over the first time period (or a different time period). Additionally, or alternatively, the one or more time sequences of PSU telemetry data 416 can include, for instance, a third time sequence of current over the first time period (or a different time period). Additionally, or alternatively, the one or more time sequences of PSU telemetry data 416 can include, for instance, a fourth time sequence of power over the first time period (or a different time period). Additionally, or alternatively, the one or more time sequences of PSU telemetry data 416 can include, for instance, a fifth time sequence of internal temperature over the first time period (or a different time period). Additionally, or alternatively, the one or more time sequences of PSU telemetry data 416 can include, for instance, a sixth time sequence of PMBus states (and/or warnings) over the first time period (or a different time period).

In some embodiments, additionally, or alternatively, the telemetry collection engine 401 can collect one or more time sequences of fan telemetry data 417. The one or more time sequences of fan telemetry data 417 can include, for instance, a first time sequence of RPM of the fan over the first time period (or a different time period). Additionally, or alternatively, the one or more time sequences of fan telemetry data 417 can include, for instance, a second time sequence of PWM duty circle of the fan over the first time period (or a different time period). Additionally, or alternatively, the one or more time sequences of fan telemetry data 417 can include, for instance, a third time sequence of motor current of the fan over the first time period (or a different time period). Additionally, or alternatively, the one or more time sequences of fan telemetry data 417 can include, for instance, a fourth time sequence of power consumption of the fan over the first time period (or a different time period).

In some embodiments, additionally, or alternatively, the telemetry collection engine 401 can collect one or more time sequences of VRM telemetry data 418. The one or more time sequences of VRM telemetry data 418 can include, for instance, a first time sequence of temperature for the VRM over the first time period (or a different time period). Additionally, or alternatively, the one or more time sequences of VRM telemetry data 418 can include a second time sequence of a stability of output voltage (if readable) over the first time period (or a different time period). Additionally, or alternatively, the one or more time sequences of VRM telemetry data 418 can include a third time sequence of a balanced state of phase current (if readable) over the first time period (or a different time period).

In some embodiments, the LADP engine 402 can process the one or more time sequences of CPU telemetry data 411, the one or more time sequences of SSD telemetry data 413, and/or the one or more time sequences of PCIe telemetry data 415, as described above. Repeated descriptions are omitted herein for the sake of brevity.

In some embodiments, the LADP engine 402 can process the one or more time sequences of PSU telemetry data 416, the one or more time sequences of fan telemetry data 417, and/or the one or more time sequences of VRM telemetry data 418, using one or more machine learning (ML) models 451 configured to run in the SMM.

In some embodiments, the one or more ML models 451 can include a first ML model. The first ML model can be an autoencoder trained to process a combined PSU telemetry data input, to generate an autoencoder output that indicates a health condition of the PSU 446. The combined PSU telemetry data input can be generated based on processing a voltage value, a current value, a temperature value, and/or a RPM of a fan associated with the PSU 446. The autoencoder can be trained in an unsupervised manner or self-supervised manner.

In some embodiments, the one or more ML models can include a second ML model. The second ML model can be an insolation forest or a decision tree model, trained to process a combined fan telemetry data input, to generate a forest/tree output that indicates a health condition of the fan 447. The combined fan telemetry data input can be a RPM of the fan 447, a PWM value, a motor current, and/or a temperature of a region that hosts the fan 447. A set of training instances can be generated to train the second ML model. The set of training instances can include a training instance that includes a training instance input and a ground truth output. For example, the training instance input can be derived from a first RPM of the fan 447, a first PWM value, a first motor current, and a first temperature of a region that hosts the fan 447, that are associated with the fan 447, where the first PWM is beyond a predetermined range of PWM values for the fan 447, the RPM is low, and the first motor current is abnormal. In this example, the training instance output can be a label or indicator indicating malfunction of the fan 447. The training instance input can be processed, using the second ML model, to generate a training instance output. The training instance output can be compared with the ground truth output to determine a deviation. Based on the deviation between the training instance output and the ground truth output, parameters of the second ML model can be modified or fine-tuned.

In some embodiments, the one or more ML models can include a third ML model. The third ML model can be trained to process a combined VRM telemetry data input, to generate a model output that indicates a health condition (e.g., overheat or not) of the VRM 448. The combined VRM telemetry data input can be derived from a temperature of the VRM 448, a load or current of a hardware component (e.g., CPU, or a graphical processing unit “GPU”) to which the VRM 448 supplies power, and/or a heat dissipation effect of a fan near the VRM 448.

In various embodiments, the PMA engine 403 can determine one or more mitigations actions based on processing the set of telemetry data using the LADP engine 402. For example, other than the mitigation actions described in association with FIG. 3, the PMA engine 403 can transmit a command to a BMC that asks the BMC to force switching of the PSU 446 to a spare PSU, in response to the LADP engine 402 predicts the PSU to malfunction. In some embodiments, if the LADP engine 402 predicts that the fan 447 is to malfunction or a performance of the fan degrades, the PMA engine 403 can request the BMC or an embedded controller of the server system, via SMM, to adjust the PWM duty cycles of fans associated with the fan 447, or to increase RPM of the associated fans, to compensate a loss of heat-dissipation.

In some embodiments, if the LADP engine 402 predicts that the associated fans still fail to satisfy a need for heat dissipation of the server system, the PMA engine 403 can perform throttling for one or more core components (e.g., CPU, PCIe device) that are negatively impacted by the fan 447, to reduce an occurrence of over heat.

In some embodiments, if the LADP engine 402 predicts that the VRM 448 has a temperature continuously exceeds a temperature threshold or experiences unstable power supply, the PMA engine 403 can restrict performance or reduce a frequency of a CPU core (or memory channel) to which the VRM 448 supplies power, thereby reducing a load or thermal stress of the VRM 408.

By training and accessing the one or more ML models, the LADP engine 402 can more efficiently predict a health condition for the server system, even when there is a complex malfunction situation for the server system.

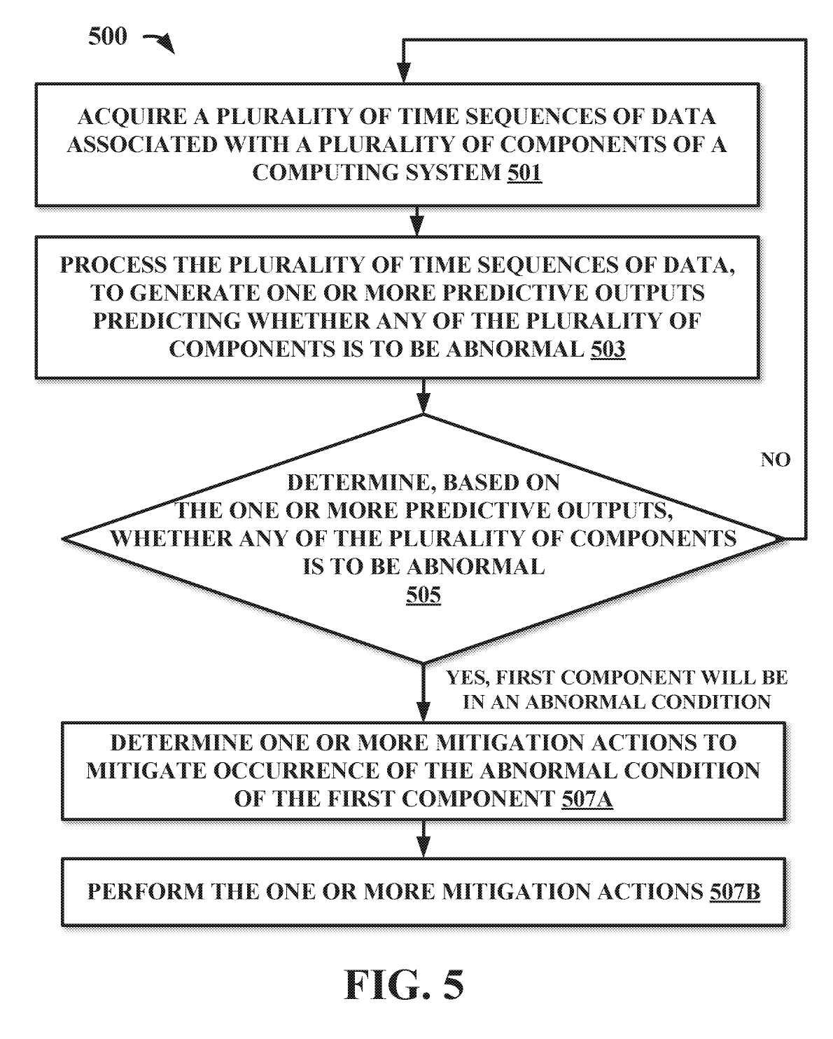

FIG. 5 illustrates an example method for monitoring and predicting health conditions of multiple components for a system, according to one or more embodiments of the present disclosure. A system for performing the method 500 can include one or more processors, memory, and/or other component(s) of computing device(s) (e.g., a server, a client device, and/or other computing devices). The system can be of varying types including a server, computing cluster, blade server, server farm, a workstation, or any other data processing or monitoring system or computing device. The various stages (blocks) need to be performed in the order shown except where otherwise apparent.

Due to the ever-changing nature of computers and networks, the description of computing systems depicted in various figures of the present disclosure is intended only as a specific example for purposes of illustrating some implementations. Many other configurations of systems and devices are possible having more or fewer components than those depicted in the figures. Moreover, while operations of the method 500 are shown in a particular order, this is not meant to be limiting. One or more operations may be reordered, omitted, and/or added.

In various embodiments, as shown in FIG. 5, at stage 501, the system acquires a plurality of time sequences of data (e.g., telemetry data) associated with a plurality of components (e.g., hardware components) of a computing system (e.g., a server, a server system, or other electronic system). The system can be, for instance, a health condition monitoring and prediction system 200 depicted in FIG. 2A (or in other figures or elsewhere of this disclosure). Such health condition monitoring and prediction system may be applied to monitor and/or predict health condition of a computing system (or an electronic system) such as a server system having one or more servers, a high-end workstation, a personal electronic device (e.g., laptop), an industrial control system (e.g., a computer numerical control “CNC” machine), a medical device (e.g., MRI or CT scanner), a or a traffic signal controlling system.

In some embodiments, the plurality of time sequences of data associated with the plurality of components of the electronic system include: a first time sequence of data associated with a first component of the electronic system, and a second time sequence of data associated with a second component of the electronic system, the first and second components being of different types. In some embodiments, the first time sequence of data associated with the first component is sampled at a first sampling frequency, and the second time sequence of data associated with the second component is sampled at a second sampling frequency. The second sampling frequency may be the same as, or different from the first sampling frequency.

In various embodiments, at stage 503, the system processes the plurality of time sequences of data (e.g., telemetry data), to generate one or more predictive outputs predicting whether any of the plurality of components is to be abnormal (e.g., to malfunction or to have degraded performance). In some embodiments, each of the plurality of components is a hardware component. In some embodiments, the plurality of components can include at least one hardware component. In some embodiments, additionally or alternatively, the plurality of components can include other types of component(s).

In various embodiments, at stage 505, the system determines, based on the generated one or more predictive outputs, whether any of the plurality of components is to be abnormal (e.g., malfunction).

In various embodiments, in response to determining that the one or more predictive outputs comprising a first predictive output indicating that a first component (e.g., a first hardware component), of the plurality of hardware components, is to be in an abnormal condition (e.g., malfunction) at a predicted time, the system determines one or more proactive mitigation actions (sometimes simply referred to as “mitigation action”) to mitigate the predicted abnormal condition of the first component (507A). For example, the system may determine one or more mitigation actions that prevent the first component (e.g., the first hardware component) from being in the abnormal condition. In various embodiments, the system performs the one or more proactive mitigation actions (“the one or more mitigation actions”) prior to the predicted time (507B).

In various embodiments, in response to determining that the one or more predictive outputs indicate no abnormal condition (e.g., malfunction) for the plurality of hardware components, the system continues monitoring the plurality of components (e.g., hardware components).

In various embodiments, the plurality of components include one or more hardware components. The one or more hardware components include a central processing unit (CPU), a storage device, and/or a peripheral component interconnect express (PCIe) device. In some embodiments, acquiring the plurality of time sequences of data (e.g., telemetry data) associated with the plurality of components includes: acquiring one or more time sequences of CPU telemetry data associated with the CPU, acquiring one or more time sequences of storage telemetry data associated with the storage device, and/or acquiring one or more time sequences of PCIe telemetry data associated with the PCIe device.

In some embodiments, the one or more time sequences of CPU telemetry data can be acquired from one or more MSRs as described above, and can be acquired through execution of SMM code or UEFI code. In some embodiments, the one or more time sequences of storage telemetry data associated with the storage device can be acquired by execution of UEFI code or SMM code, e.g., a Get Log Page command. In some embodiments, the one or more time sequences of PCIe telemetry data associated with the PCIe device can be acquired by execution of UEFI code or SMM code that access configuration of the PCIe device.

In some embodiments, acquiring one or more time sequences of CPU telemetry data includes: acquiring a first time sequence of CPU telemetry data from a machine check architecture (MCA) bank of the CPU that comprises one or more model-specific registers (MSRs), where the first time sequence of CPU telemetry data includes a series of corrected errors associated the CPU or a series of uncorrected errors associated with the CPU. Additionally or alternatively, acquiring one or more time sequences of CPU telemetry data includes: acquiring a second time sequence of CPU telemetry data from one or more error count registers of the CPU, where the second time sequence of CPU telemetry data includes a series of error counts associated with the CPU. The series of error counts may include a first series of a total number of errors corrected for a memory controller of the CPU that couples the CPU with a memory and/or a second series of a total number of errors corrected for a QuickPath Interconnect (QPI) or an Ultra Path Interconnect (UPI) that couples the CPU with an additional CPU.

Additionally or alternatively, acquiring one or more time sequences of CPU telemetry data includes: acquiring a third time sequence of CPU telemetry data associated with the CPU, where the third time sequence of CPU telemetry data is collected using a thermal sensor and includes a series of temperatures values associated with a temperature of the CPU. Additionally or alternatively, acquiring one or more time sequences of CPU telemetry data includes: acquiring a fourth time sequence of CPU telemetry data associated with the CPU from the one or more MSRs or from power management firmware of the CPU, where the fourth time sequence of CPU telemetry data includes a series of current operating frequencies, voltages, or power consumptions, associated with the CPU. The first time sequence, the second time sequence, the third time sequence, and the fourth time sequence, of CPU telemetry data, correspond to a same time period or correspond to different time periods.

In some embodiments, acquiring one or more time sequences of storage telemetry data includes: acquiring a first time sequence of storage telemetry data reflecting a variation in a percentage of available space for the storage device, acquiring a second time sequence of storage telemetry data reflecting a variation in a total number of media and data integrity errors detected for the storage device, acquiring a third time sequence of storage telemetry data reflecting a variation in a percentage of a life used for the data storage, acquiring a fourth time sequence of storage telemetry data reflecting a variation in a temperature of the data storage, and/or acquiring a fifth time sequence of storage telemetry data reflecting a variation in a critical warning for a state of the data storage. The first time sequence, the second time sequence, the third time sequence, the fourth time sequence, and the fifth time sequence, of storage telemetry data, correspond to a same time period or correspond to different time periods.

In some embodiments, acquiring one or more time sequences of PCIe telemetry data includes: acquiring a first time sequence of PCIe telemetry data reflecting a series of corrected errors associated with the PCIe device, acquiring a second time sequence of PCIe telemetry data reflecting a series of uncorrected errors associated with the PCIe device, acquiring a third time sequence of PCIe telemetry data reflecting a variation in a link speed of a PCIe link connected to the PCIe device, and/or acquiring a fourth time sequence of PCIe telemetry data reflecting a variation in a bandwidth of a PCIe link connected to the PCIe device. The first time sequence, the second time sequence, the third time sequence, and the fourth time sequence, of PCIe telemetry data, correspond to a same time period or correspond to different time periods.

In some embodiments, processing the plurality of time sequences of data (e.g., telemetry data), to generate one or more predictive outputs includes: processing a respective time sequence, of the plurality of time sequences of data, using an exponentially weighted moving average (EWMA) approach or a simple moving average(SMA) approach, to determine a trend of data variation (e.g., telemetry data variation) for the respective time sequence.

In some embodiments, the first component is the CPU. In this case, determining one or more proactive mitigation actions to mitigate the predicted abnormal condition (e.g., malfunction or other condition) of the first component includes: generating a high priority hardware error signal to a BMC or to an operating system, and transmitting the high priority hardware error signal to the BMC or to the operating system.

In some embodiments, the first component is the CPU, and determining one or more proactive mitigation actions to mitigate the predicted abnormal condition (e.g., malfunction or other condition) of the first component includes: flagging the CPU such that operation of the CPU is prohibited next time the server system is initiated.

In some embodiments, the first component is the storage device or the PCIe device. In this case, determining one or more proactive mitigation actions to mitigate the predicted abnormal condition of the first component includes: prohibiting loading of a UEFI driver for the storage device or the PCIe device.

In some embodiments, the first component is the storage device or the PCIe device, and determining one or more proactive mitigation actions to mitigate the predicted abnormal condition of the first component includes: flagging the storage device or the PCIe device as “disabled” or “non present” in an ACPI table, to prevent an operating system from attempting to access the storage device or the PCIe device.

In some embodiments, the plurality of components additionally, or alternatively, comprise a power supply unit (PSU), a system fan, or a voltage regulator module (VRM). In some embodiments, processing the plurality of time sequences of data (e.g., telemetry data), to generate one or more predictive outputs includes: processing the plurality of time sequences of data (e.g., telemetry data), using one or more machine learning (ML) models, to generate the one or more predictive outputs.

In some embodiments, acquiring the plurality of time sequences of data (e.g., telemetry data) associated with the plurality of components includes: acquiring one or more time sequences of PSU telemetry data associated with the PSU, acquiring one or more time sequences of fan telemetry data associated with the fan, and/or acquiring one or more time sequences of VRM telemetry data associated with the VRM.

In some embodiments, the one or more time sequences of PSU telemetry data can be acquired by execution of SMM or UEFI code to retrieve such data from a BMC (or EC) that accesses the PSU via an I2C/PMBus interface. In some embodiments, the one or more time sequences of fan telemetry data associated with the storage device can be acquired by execution of UEFI code or SMM code, to retrieve such data from a BMC (or EC). In some embodiments, the one or more time sequences of VRM telemetry data can be acquired by execution of UEFI code or SMM code to retrieve such data from a BMC (or EC) or retrieve such data directly from the VRM through an I2C/SVID port.

In some embodiments, acquiring the one or more time sequences of PSU telemetry data includes: acquiring a first time sequence of PSU telemetry data reflecting a variation in a value for an electrical parameter of the PSU, the electrical parameter being an input voltage, an output voltage, a current, or a power; acquiring a second time sequence of PSU telemetry data reflecting a variation in a value for a temperature of the PSU; acquiring a third time sequence of PSU telemetry data reflecting a variation in a status of a power of the PSU; acquiring a fourth time sequence of PSU telemetry data reflecting a variation in a malfunction indicator of the PSU; and/or acquiring a fifth time sequence of PSU telemetry data reflecting a variation in warnings of the PSU. The first time sequence, the second time sequence, the third time sequence, the fourth time sequence, and the fifth time sequence, of PSU telemetry data, correspond to a same time period or correspond to different time periods.

In some embodiments, acquiring the one or more time sequences of fan telemetry data includes: acquiring a first time sequence of fan telemetry data reflecting a variation in a RPM of the fan, acquiring a second time sequence of fan telemetry data reflecting a variation in duty cycle associated with a Pulse Width Modulation (PWM) controlling signal that is transmitted to a fan, acquiring a third time sequence of fan telemetry data reflecting a variation in an operating status of the fan, acquiring a fourth time sequence of fan telemetry data reflecting a variation in a current of the fan, and/or acquiring a fifth time sequence of fan telemetry data reflecting a variation in a power of the fan. The first time sequence, the second time sequence, the third time sequence, the fourth time sequence, and the fifth time sequence, of fan telemetry data, correspond to a same time period or correspond to different time periods.

In some embodiments, acquiring the one or more time sequences of VRM telemetry data includes: acquiring a first time sequence of VRM telemetry data from a temperature sensor within a VRM region in proximity to one or more core hardware components of the server system, where the first time sequence of VRM telemetry data reflects a variation in a value of a temperature associated with the VRM; acquiring a second time sequence of VRM telemetry data reflecting a variation in an output voltage associated with the VRM; acquiring a third time sequence of VRM telemetry data reflecting a variation in an output current associated with the VRM; and/or acquiring a fourth time sequence of VRM telemetry data reflecting a variation in a phase health condition associated with the VRM. The first time sequence, the second time sequence, the third time sequence, and the fourth time sequence, of VRM telemetry data, correspond to a same time period or correspond to different time periods.

In various embodiments, another method is provided and includes: acquiring a plurality of time sequences of data (e.g., telemetry data) associated with a plurality of components (e.g., a plurality of hardware components) of a server system; processing the plurality of time sequences of telemetry data, to generate one or more predictive outputs predicting whether any of the plurality of hardware components is to be abnormal (e.g., to malfunction, or to have degraded performance, etc.); determining, based on the generated one or more predictive outputs, whether any of the plurality of components is to be abnormal (e.g., malfunction); in response to determining that the one or more predictive outputs include a first predictive output indicating that a first component, of the plurality of components, is to be in an abnormal condition (e.g., malfunction): determining one or more proactive mitigation actions (“one or more mitigation actions”) to prevent the first hardware component from being in the abnormal condition, and performing the one or more mitigation actions; and in response to determining that the one or more predictive outputs predicting no abnormal condition for the plurality of components, continuing monitoring the plurality of components.

In some embodiments, the plurality of components can include a CPU, a storage device, a PCIe device, a PSU, a fan, and/or a VRM. The one or more mitigation actions may include a first set of CPU mitigation actions including: disabling the CPU (e.g., by modifying the ACPI MADT or by using a MSR) when the UEFI is initiated next time or when the SMM is running. Additionally or alternatively, the one or more mitigation actions may include a second set of storage device mitigation actions, including: prohibiting the loading of a drive for the storage device (and/or labeling the storage device as “not in use”) during UEFI; during the SMM, notifying the BMC or an operating system of a computing system which uses the disclosed method/system to replace the storage device; and/or during the SMM, monitoring whether the storage device is in a “read-only” mode. Additionally or alternatively, the one or more mitigation actions may include a third set of PCIe mitigation actions, including: degrading a link speed of the PCIe device (e.g., from Gen4 to Gen3) during UEFI stage, and if such degrading fails, disabling the PCIe device.

Additionally or alternatively, the one or more mitigation actions may include a fourth set of PSU mitigation actions, including: switching the PSU (which is predicted to malfunction) to a space PSU by execution of SMM code that directs a BMC or EC.

Additionally or alternatively, the one or more mitigation actions may include a fifth set of fan mitigation actions, including: increasing fan speed of one or more fans in proximity to a key component (e.g., the CPU) by execution of SMM code that directs a BMC or EC; and/or throttling the CPU if a temperature of the CPU continues to exceed an upper temperature limit.

Additionally or alternatively, the one or more mitigation actions may include a sixth set of VRM mitigation actions, including: by execution of related SMM code, throttling one or more cores of the CPU, reducing a load of the VRM, and/or adjusting a phase of the VRM.

In various embodiments, the method further includes: in response to determining that the one or more predictive outputs comprising the first predictive output indicating that the first component (e.g., a first hardware component), of the plurality of components, is to be in an abnormal condition (e.g., malfunction): generating an entry in a database to record the first predictive output indicating that the first component is to be abnormal (e.g., malfunction) and/or the one or more proactive mitigation actions determined for the first component.

In various embodiments, a system is provided. The system includes at least one processor, and memory storing instructions that, when executed by the at least one processor, cause the at least one processor to: acquire a plurality of time sequences of data (e.g., telemetry data and/or other types of condition-indicating data) associated with a plurality of components (e.g., hardware, firmware, and/or software components) of a server system; process the plurality of time sequences of data, to generate one or more predictive outputs predicting whether any of the plurality of components is to be abnormal (e.g., malfunction); determine, based on the generated one or more predictive outputs, whether any of the plurality of components is to be abnormal (e.g., malfunction); in response to determining that the one or more predictive outputs comprise a first predictive output indicating that a first component (e.g., a first hardware component), of the plurality of hardware components, is to be in an abnormal condition (e.g., to malfunction, or have a degraded performance, at a predicted time): determine one or more proactive mitigation actions to mitigate occurrence of the predicted abnormal condition of the first component, and perform the one or more proactive mitigation actions (e.g., prior to the predicted time); and in response to determining that the one or more predictive outputs predicting no abnormal condition for the plurality of components, continue monitoring the plurality of components.

The above descriptions and descriptions of removal apparatus and method or system depicted in various figures of the present disclosure are intended only as a specific example for purposes of illustrating some implementations. Many other configurations of systems and apparatus are possible having more or fewer components than those described above or depicted in the figures. For example, in some embodiments, the plurality of hardware components additionally, or alternatively, comprise a graphic processing unit (GPU), an electronic control unit (ECUs in a vehicle), a router, a switch, a transceiver, etc. In this case, corresponding telemetry data can be collected and processed to determine or predict whether any of these components malfunctions or will malfunction. Moreover, while operations of the method 500 are shown in a particular order, this is not meant to be limiting. One or more operations may be reordered, omitted, and/or added.

It’s appreciated that different features from different embodiments may be combined with and/or exchanged for one another. In addition, those of ordinary skill in the art will recognize that various changes and modifications of the various implementations described herein can be made without departing from the scope and spirit of the present disclosure. The terms and words used in the descriptions and claims of the present disclosure are not limited to the bibliographical meanings, and are merely used by the inventor to enable a clear and consistent understanding of the present disclosure. Accordingly, it should be apparent to those skilled in the art that the description of various embodiments of the present disclosure is provided for the purpose of illustration only and not for the purpose of limiting the present disclosure as defined by the appended claims and their equivalents.

What is claimed is:

1. A method, comprising:
acquiring a plurality of time sequences of data associated with a plurality of components of an electronic system;
processing the plurality of time sequences of data to generate one or more predictive outputs indicating whether any of the plurality of components will be in an abnormal condition;
determining, based on a first predictive output of the one or more predictive outputs, that at least a first component of the plurality of components will be in an abnormal condition at a predicted time;
determining one or more mitigation actions to mitigate occurrence of the abnormal condition for the first component; and
performing the one or more mitigation actions prior to the predicted time.

2. The method of claim 1, wherein:
the plurality of time sequences of data associated with the plurality of components of the electronic system comprises a first time sequence of data associated with a first component of the electronic system and a second time sequence of data associated with a second component of the electronic system, the first and second components being of different types,
the first time sequence of data associated with the first component is sampled at a first sampling frequency, and
the second time sequence of data associated with the second component is sampled at a second sampling frequency, the second sampling frequency being different from the first sampling frequency.

3. The method of claim 1, wherein the plurality of components comprise one or more hardware components, the one or more hardware components comprising a central processing unit (CPU), a storage device, and/or a peripheral component interconnect express (PCIe) device, and wherein acquiring the plurality of time sequences of data associated with the plurality of components comprises:
acquiring one or more time sequences of CPU telemetry data associated with the CPU,
acquiring one or more time sequences of storage telemetry data associated with the storage device, and/or
acquiring one or more time sequences of PCIe telemetry data associated with the PCIe device.

4. The method of claim 3, wherein acquiring one or more time sequences of CPU telemetry data comprises:
acquiring a first time sequence of CPU telemetry data from a machine check architecture (MCA) bank of the CPU that comprises one or more model-specific registers (MSRs), the first time sequence of CPU telemetry data comprising a series of corrected errors associated the CPU or a series of uncorrected errors associated with the CPU,
acquiring a second time sequence of CPU telemetry data from one or more error count registers of the CPU, the second time sequence of CPU telemetry data comprising a series of error counts associated with the CPU, the series of error counts comprising a first series of a total number of errors corrected for a memory controller of the CPU that couples the CPU with a memory and/or a second series of a total number of errors corrected for a QuickPath Interconnect (QPI) or an Ultra Path Interconnect (UPI) that couples the CPU with an additional CPU,
acquiring a third time sequence of CPU telemetry data associated with the CPU, the third time sequence of CPU telemetry data being collected using a thermal sensor and comprising a series of temperatures values associated with a temperature of the CPU, and/or
acquiring a fourth time sequence of CPU telemetry data associated with the CPU from the one or more MSRs or from power management firmware of the CPU, the fourth time sequence of CPU telemetry data comprising a series of current operating frequencies, voltages, or power consumptions, associated with the CPU,
wherein the first time sequence, the second time sequence, the third time sequence, and the fourth time sequence, of CPU telemetry data, correspond to a same time period or correspond to different time periods.

5. The method of claim 3, wherein acquiring one or more time sequences of storage telemetry data comprises:
acquiring a first time sequence of storage telemetry data reflecting a variation in a percentage of available space for the storage device,
acquiring a second time sequence of storage telemetry data reflecting a variation in a total number of media and data integrity errors detected for the storage device,
acquiring a third time sequence of storage telemetry data reflecting a variation in a percentage of a life used for the data storage,
acquiring a fourth time sequence of storage telemetry data reflecting a variation in a temperature of the data storage, and/or
acquiring a fifth time sequence of storage telemetry data reflecting a variation in a critical warning for a state of the data storage,
wherein the first time sequence, the second time sequence, the third time sequence, the fourth time sequence, and the fifth time sequence, of storage telemetry data, correspond to a same time period or correspond to different time periods.

6. The method of claim 3, wherein acquiring one or more time sequences of PCIe telemetry data comprises:
acquiring a first time sequence of PCIe telemetry data reflecting a series of corrected errors associated with the PCIe device,
acquiring a second time sequence of PCIe telemetry data reflecting a series of uncorrected errors associated with the PCIe device,
acquiring a third time sequence of PCIe telemetry data reflecting a variation in a link speed of a PCIe link connected to the PCIe device, and/or
acquiring a fourth time sequence of PCIe telemetry data reflecting a variation in a bandwidth of a PCIe link connected to the PCIe device,
wherein the first time sequence, the second time sequence, the third time sequence, and the fourth time sequence, of PCIe telemetry data, correspond to a same time period or correspond to different time periods.

7. The method of claim 1, wherein processing the plurality of time sequences of telemetry data, to generate one or more predictive outputs comprises:
processing a respective time sequence, of the plurality of time sequences of telemetry data, using an exponentially weighted moving average (EWMA) approach or a simple moving average (SMA) approach, to determine a trend of telemetry data variation for the respective time sequence.

8. The method of claim 1, wherein the first component is a CPU, and wherein determining one or more mitigation actions to mitigate the predicted abnormal condition of the first component comprises:
generating a high priority hardware error signal to a BMC or to an operating system, and
transmitting the high priority hardware error signal to the BMC or to the operating system.

9. The method of claim 1, wherein the first component is a CPU, and wherein determining one or more mitigation actions to mitigate the predicted abnormal condition of the first component comprises:
flagging the CPU such that operation of the CPU is prohibited next time the electronic system is initiated.

10. The method of claim 1, wherein the first component is a storage device or a PCIe device, and wherein determining one or more mitigation actions to mitigate the predicted abnormal condition of the first component comprises:
prohibiting loading of a UEFI driver for the storage device or the PCIe device.

11. The method of claim 1, wherein the first component is a storage device or a PCIe device, and wherein determining one or more mitigation actions to mitigate the predicted abnormal condition of the first component comprises:
flagging the storage device or the PCIe device as “disabled” or “non present” in an ACPI table, to prevent an operating system from attempting to access the storage device or the PCIe device.

12. The method of claim 1, wherein the plurality of components comprise a power supply unit (PSU), a system fan, or a voltage regulator module (VRM).

13. The method of claim 12, wherein processing the plurality of time sequences of data, to generate one or more predictive outputs comprises:
processing the plurality of time sequences of data, using one or more machine learning (ML) models, to generate the one or more predictive outputs.

14. The method of claim 12, wherein acquiring the plurality of time sequences of data comprises:
acquiring one or more time sequences of PSU telemetry data associated with the PSU,
acquiring one or more time sequences of fan telemetry data associated with a fan, and/or
acquiring one or more time sequences of VRM telemetry data associated with the VRM.

15. The method of claim 14, wherein acquiring the one or more time sequences of PSU telemetry data comprises:
acquiring a first time sequence of PSU telemetry data reflecting a variation in a value for an electrical parameter of the PSU, the electrical parameter being an input voltage, an output voltage, a current, or a power,
acquiring a second time sequence of PSU telemetry data reflecting a variation in a value for a temperature of the PSU,
acquiring a third time sequence of PSU telemetry data reflecting a variation in a status of a power of the PSU,
acquiring a fourth time sequence of PSU telemetry data reflecting a variation in a malfunction indicator of the PSU, and/or
acquiring a fifth time sequence of PSU telemetry data reflecting a variation in warnings of the PSU,
wherein the first time sequence, the second time sequence, the third time sequence, the fourth time sequence, and the fifth time sequence, of PSU telemetry data, correspond to a same time period or correspond to different time periods.

16. The method of claim 14, wherein acquiring the one or more time sequences of fan telemetry data comprises:
acquiring a first time sequence of fan telemetry data reflecting a variation in a Revolutions Per Minute (RPM) of the fan,
acquiring a second time sequence of fan telemetry data reflecting a variation in duty cycle associated with a Pulse Width Modulation (PWM) controlling signal that is transmitted to a fan,
acquiring a third time sequence of fan telemetry data reflecting a variation in an operating status of the fan,
acquiring a fourth time sequence of fan telemetry data reflecting a variation in a current of the fan, and/or
acquiring a fifth time sequence of fan telemetry data reflecting a variation in a power of the fan,
wherein the first time sequence, the second time sequence, the third time sequence, the fourth time sequence, and the fifth time sequence, of fan telemetry data, correspond to a same time period or correspond to different time periods.

17. The method of claim 14, wherein acquiring the one or more time sequences of VRM telemetry data comprises:
acquiring a first time sequence of VRM telemetry data from a temperature sensor within a VRM region in proximity to one or more core hardware components of the electronic system, the first time sequence of VRM telemetry data reflecting a variation in a value of a temperature associated with the VRM,
acquiring a second time sequence of VRM telemetry data reflecting a variation in an output voltage associated with the VRM,
acquiring a third time sequence of VRM telemetry data reflecting a variation in an output current associated with the VRM, and/or
acquiring a fourth time sequence of VRM telemetry data reflecting a variation in a phase health condition associated with the VRM,
wherein the first time sequence, the second time sequence, the third time sequence, and the fourth time sequence, of VRM telemetry data, correspond to a same time period or correspond to different time periods.

18. A method, comprising:
acquiring a plurality of time sequences of data associated with a plurality of components of a computing system;
processing the plurality of time sequences of data, to generate one or more predictive outputs indicating whether any of the plurality of components will be in an abnormal condition;
determining, based on a first predictive output of the generated one or more predictive outputs, that a first component will be in an abnormal condition;
determining one or more mitigation actions to prevent the first component from entering the abnormal condition; and
performing the one or more mitigation actions.

19. The method of claim 18, further comprising:
generating an entry in a database to record the first predictive output and/or the one or more mitigation actions determined for the first component.

20. A system, comprising:
at least one processor, and
memory storing instructions that, when executed by the at least one processor, cause the at least one processor to:
acquire a plurality of time sequences of data associated with a plurality of hardware components of a server system;
process the plurality of time sequences of telemetry data, to generate one or more predictive outputs predicting whether any of the plurality of hardware components is to be in an abnormal condition;
determine, based on a first predictive output of the generated one or more predictive outputs, that a first hardware component will be in an abnormal condition;
determine one or more mitigation actions to prevent the first hardware component from being in the abnormal condition; and
perform the one or more mitigation actions.
